(19) United States
(12) Patent Application Publication
(10) Pub. No.: US 2009/0276390 A1
(43) Pub. Date: Nov. 5, 2009

(54) Modeling support system, modeling support method, and modeling support program

(75) Inventors: Satoru Watanabe, Kawasaki (JP); Masashi Uyama, Kawasaki (JP); Youji Kohda, Kawasaki (JP); Mitsuru Oda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/379,871

(22) Filed: Mar. 3, 2009

(30) Foreign Application Priority Data
Apr. 30, 2008 (JP) JP2008-118238

(51) Int. Cl. G06N 5/02; G06Q 10/00; G06F 17/10

(52) U.S. Cl. 706/54; 705/10; 703/2

(57) ABSTRACT

A modeling support system is provided in which a model structure is extracted from stored models so as to improve a resulting prediction model using the extracted structure. In a modeling support system 1, when information processors 15a to 15c analyze a phenomenon using covariance structure for modeling and request the modeling support system 1 for supporting the modeling, a model controller 4 acquires and controls observed variables, latent variables, and the associations between the variables of the object model. Then, a similar structure extractor 78 of a model extractor 7 compares the object model with reference models stored in a model recorder, and extracts a partial structure of the reference model having a structure similar to a partial structure of the object model as a similar structure, and then the model controller notifies the extracted similar structure to the information processor.

### BACKGROUND OF THE INVENTION

1. Field of the Invention

The present invention relates to a computer system for supporting modeling to predict a fluctuating phenomenon such as monthly sales of a store.

2. Description of the Related Art

In late years, sensor networks have been widely deployed, which is facilitating the collection of data which represents fluctuations of features of objects in various industrial fields (for example, sales of commodities, performance of machines, vital signs of organs, and the like). Such data can be useful information at various sites including retailers and maintenance facilities. Thus, applications of a statistical model (a mathematical expression) to such data have been attempted to understand the essence of the phenomena represented by the data, to predict future phenomena, and to early find the changes of characteristics.

Such attempts include regression analysis of data representing past phenomena for generating a model represented by a regression equation. The model enables the analysis of past phenomena or the prediction of future phenomena. In a regression equation, an object phenomenon is represented by a object variable (explained variable), and the factor affecting the phenomenon is represented by an explanatory variable. The following equation (1) is an example of the regression equation, and is the one for linear multiple regression. In the following equation (1), Y is a object variable, X1 and X2 are explanatory variables, and “a”, “b”, and “c” are coefficients of the regression. In particular, “a” is constant term and “b”, “c” are called partial regression coefficients. The regression analysis estimates numeric values of these parameters.

### [Formula 1]

Y=a+b×X1+c×X2 (1)

As an example, when sales at a store is predicted, in above formula (1), the object variable Y may represent forecasted sales at the store, the explanatory variable X1 represents the diversity of the goods displayed in the store, and the explanatory variable X2 may represent the average price of commercial products. In the case, the coefficients a, b, and c can be obtained using the data of past sales, diversity of products, and average price at a plurality of stores (for example, a plurality of chain stores). Then, for example, the owner of the store can compare the contributions of the diversity of the goods displayed in the store and the average price to the sales individually, and also predict the future sales resulting from the diversity of the goods displayed in the store and the average price, using the above formula (1).

Thus, in forming a regression equation of model for analyzing or predicting a phenomenon, the assignment of an explanatory variable which functions as a factor for explaining the phenomenon is the key. The prediction accuracy depends on the assignment for an explanatory variable. So far, however, an appropriate explanatory variable has been inevitably determined by the experience, intuition, and try-and-error of snalysts on each different field.

Then, a prediction apparatus has been disclosed in Japanese Patent Application Laid-Open No. 9-95917 for example, the apparatus being configured to update a prediction model with a large error which is obtained by a calculation using a predictive value for the prediction model and an actual value so that the most appropriate model can be determined. Also, a method for selecting a prediction model to be proposed using prediction data which is obtained by applying time-series achievement data to a plurality of prediction models is disclosed in Japanese Patent Application Laid-Open No. 2001-22729 for example.

### SUMMARY OF THE INVENTION

The above patent documents provide a prediction apparatus and a method for improving a prediction model for a certain phenomenon. As a result, an improvement of a prediction model using a number of stored past models cannot be achieved with the above apparatus and method. In addition, in the above apparatus and method, regression analysis is used to construct a prediction; thereby it is difficult to improve a prediction model by extracting a main structure of a model from observed variables and using the extracted structure.

The present invention was made in view of the above problems, and one object of the present invention is to provide a modeling support system, a modeling support method, and a modeling support program for improving a prediction model by extracting a model structure from stored past models and using the extracted structure.

The present invention discloses a modeling support system in which a model is stored in a model recorder as a reference model, the model being represented by a union of a plurality of observed variables with data and a plurality of latent variables without data, and a plurality of paths indicating the associations between the variables. The reference model may be the one generated by an information processor in the past or the one generated by other system in the past. When an information processor generates a model by covariance structure analysis of a phenomenon, a model controller acquires the object model that is being generated and represented by the observed variables and latent variables and the paths. Then, receiving a request from the information processor for supporting the generation of the object model, a similar structure extractor of a model extractor compares the object model with the stored reference models, and extracts the entire structure or a partial structure of a reference model having a similar structure to the entire structure or a partial structure of the object model as a similar structure, and the extracted similar structure is notified to the information processor by the model controller. The convariance structure analysis (CSA) is one of the statistical method which investigates causal relationship, such as various kinds of social phenomenon, natural phenomena, etc. It is the statistical approach by drawing the latent variable which does not observe directly from the variable (observed variable) observed directly, and setting up a hypothesis (mathematical model) about the causal relationship of the latent variable and observed variable. Since not only covariance structure but the model which analyzes the average structure of a latent variable was developed. It is called a structural equation model (SEM) in many cases. However SEM may mean the partial model of covariance structural analysis.

In the present invention, when the information processor requests the system according to the present invention to support modeling during an object model is being generated, the system compares the object model with reference models stored in a model recorder therein, as the result of that a structure similar to the entire structure or a partial structure of the object model is extracted from a reference model, thereby the object model (prediction model) can be improved by extracting a model structure from the stored reference models and using the extracted structure.

A system disclosed herein compares an object model which is being generated with stored reference models, so that a similar structure similar to the entire structure or a partial structure of the object model is be extracted from the reference models, thereby the object model can be improved by the extraction of a model structure from the stored reference models and the use of the extracted structure.

### BRIEF DESCRIPTION OF THE DRAWINGS

FIG. 1 is a block diagram showing the functional elements of a modeling support program disclosed herein;

FIG. 2 is a path diagram showing the structure of a model B;

FIG. 3 is a diagram showing data representation of elements included in the model B;

FIG. 4 is a diagram showing one example of a structural equation of the model B;

FIG. 5 is a diagram showing one example of contents stored in a model instance database;

FIG. 6 is a path diagram showing the structure of a model A;

FIG. 7 is a diagram showing data representation of elements included in the model A;

FIG. 8 is a diagram showing one example of a structural equation of the model A;

FIG. 9 is a diagram illustrating distances between external attributes of the models A and B;

FIG. 10 is a diagram illustrating distances between elements of the models A and B;

FIG. 11 is a diagram illustrating distance between path structures of the models A and B;

FIG. 12 is a diagram illustrating distances between path coefficients of the models A and B;

FIG. 13 is a diagram illustrating distances between path coefficient signs of the models A and B;

FIG. 14 is a diagram illustrating distances between path coefficient significances;

FIG. 15 is a flowchart showing the process flow for a distance calculation;

FIG. 16 is a flowchart showing the main routine of a modeling support system;

FIG. 17 is a flowchart showing a subroutine for a partial structure extraction process;

FIG. 18 is a flowchart showing a subroutine for a similar structure extraction process;

FIG. 19 is a flowchart showing a subroutine for a common structure/aggregate structure extraction process;

FIG. 20 is a flowchart showing a subroutine for a similar generation method extraction process;

FIG. 21 is a flowchart showing a subroutine for a latent variable extraction process;

FIG. 22 is a path diagram showing the structure of a model C;

FIG. 23 is a diagram showing a structural equation of the model C;

FIG. 24 is a path diagram showing the part extracted from the model C as a partially stable structure;

FIG. 25 is a diagram showing a structural equation of a partially stable structure included in the model C;

FIG. 26 is a path diagram showing the structure of an extracted part of the similar structure of the model B;

FIG. 27 is a diagram showing the structural matrices of the similar structures of the models A and B;

FIG. 28 is a path diagram showing the structures of the parts in the model B to which latent variable names are recommended;

FIG. 29 is a path diagram showing models D and E;

FIG. 30 is a diagram showing the structural matrix of the model D;

FIG. 31 is a diagram showing the structural matrix of the model E; and

FIG. 32 is a diagram showing the structural matrices of the common structures of the models D and E.

### DETAILED DESCRIPTION OF THE PREFERRED EMBODIMENT

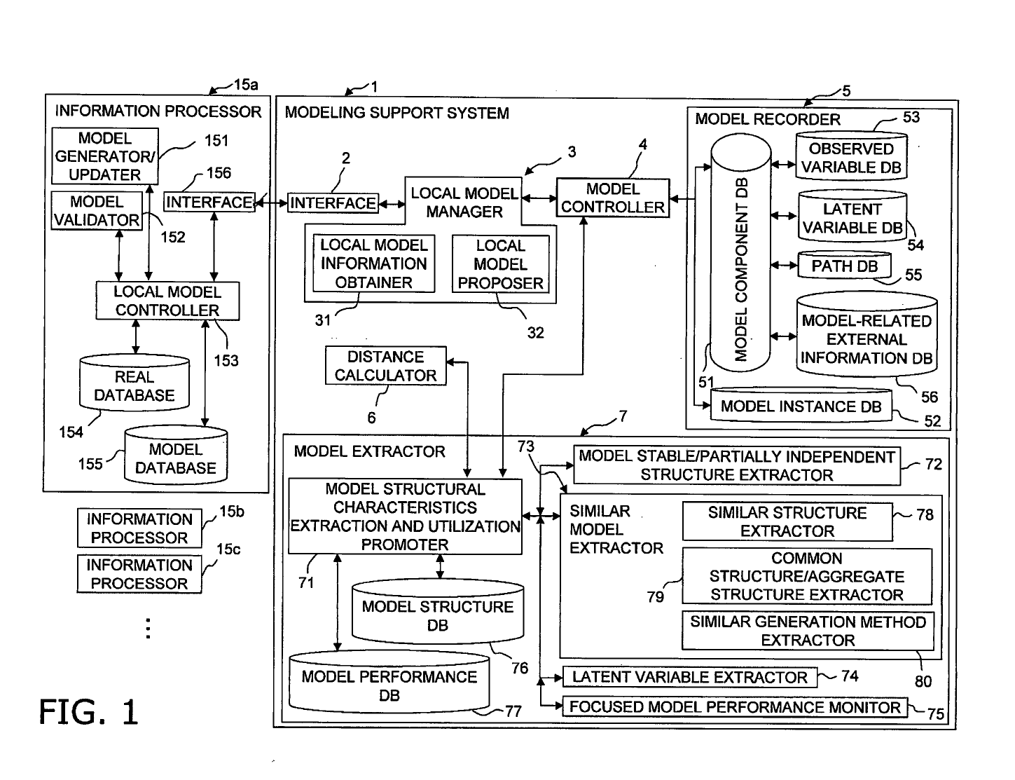

FIG. 1 is a block diagram showing the functional elements of a modeling support program, that is, the configuration of a modeling support system according to the present embodiment, with information processors of each industrial field. A modeling support system 1 is connected to information processors 15a, 15b, and 15c, via a network for example. Each of the information processor 15a, 15b, and 15c is an apparatus for predicting a future phenomenon by analyzing data which indicates a fluctuation pattern of certain object of each field for modeling and using the model. The model is data with covariance structure obtained by multivariate analysis which uses observed variables and latent variables corresponding to the factors that contribute to the target phenomenon.

### (Configuration of Information Processor)

The information processor 15a includes a model generator/updater 151 for generating and updating models at each field, a model validator 152 for validation and analysis of models by applying real data at each field to the generated models at each field, and a local model controller 153 for controlling the generated models at each field. The information processor 15a further includes a real database 154 for storing real data on each field, a model database 155 for storing elements of statistical models on each field, rating scales of test value and the like, model generating methods, and model interpretation information, and an interface (IF) 156 for data input/output between the modeling support system 1.

### (Operation of Information Processor)

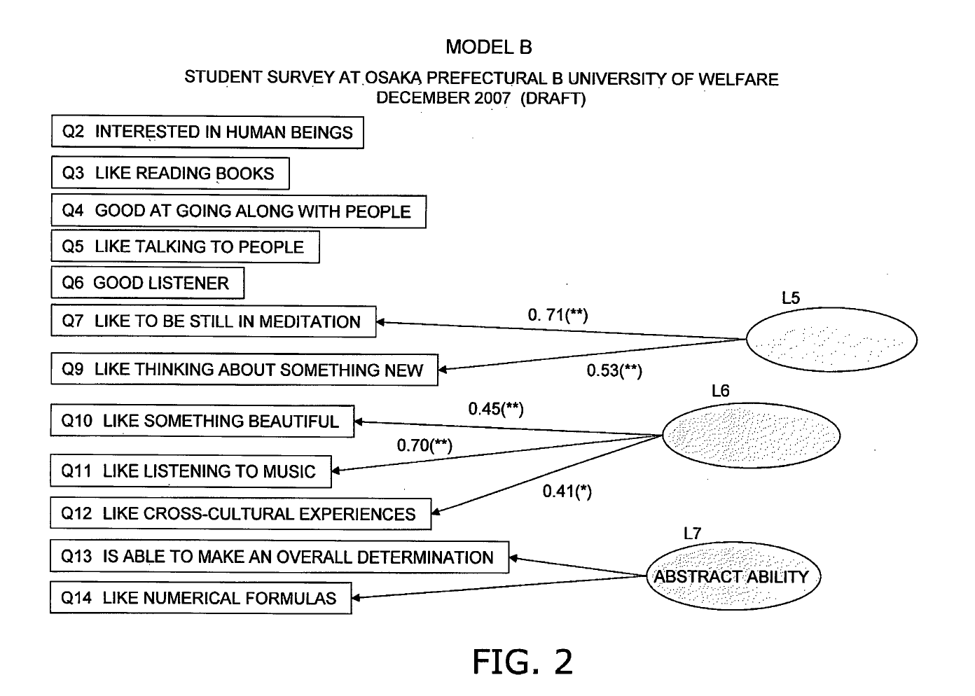

The general operation of the information processor 15a will be explained below by the following example in which a model B is generated for abstracting preferences of students from questionnaire results at B University. In the case, the model generator/updater 151 of the information processor 15a generates a model B such as that shown in FIG. 2 based on the questionnaire results using covariance structure.

In the present embodiment, a covariance structure model is represented with a union of a plurality of observed variables and a plurality of latent variables, and a plurality of paths representing the associations between the variables.

In FIG. 2, the observed variables are the survey questions described in the rectangular frames. The observed variables are variables which can be directly observed and have measured values or data as multivariate data. While, the latent variables are the ones described in the oval frames. The latent variables are variables introduced in a model which cannot be directly observed and do not have data. The latent variables are introduced as latent common causes that are present between the observed variables or other latent variables to cause correlations between other variables. The paths are configured to represent the associations between the variables, and reliability and statistical significance of the associations.

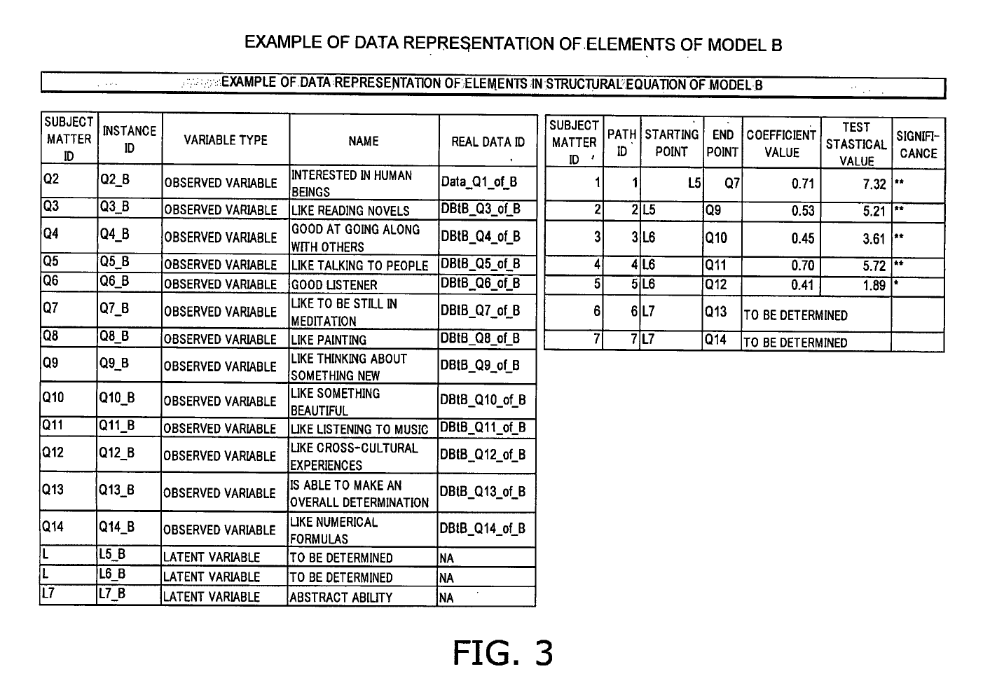

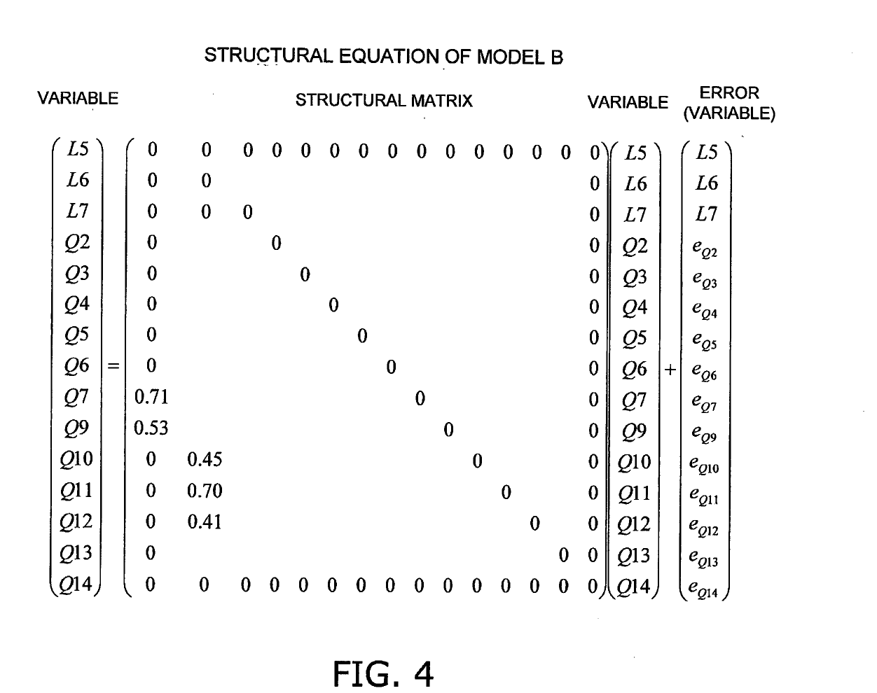

In the present embodiment, the model B shown in FIG. 2 is represented based on the data of elements as those shown in FIG. 3, and in the information processor 15a and the modeling system 1, the model B is expressed and described by a structural equation as that shown in FIG. 4 in which the representation is described by a formula. Herein, the structural equation is expressed as: a variable vector=a structural matrix having path coefficients at set points×a variable vector+an error vector.

Among the elements (observed variables, latent variables, and paths) of the structural equation for model B shown in FIG. 3, the variables include, for example, material identifying information, model instance identifying information, a variable type, a variable name, and information for identifying real data showing observed variable names. The paths includes, for example, material identifying information, path identifying information, a variable at path starting point, a variable at path end point, a coefficient value showing association between the variables, a test statistical value for a path coefficient, and statistical significance (reliability) of a path coefficient. The statistical significance is determined based on the test statistical value.

Specifically, in FIG. 2, the values indicate the coefficient values of the paths between the variables. The mark “*” represents statistical significance, and in the present embodiment, statistical significance of each path is classified in three ranks.

The (i, j)^{th} element in the structural matrix of FIG. 4 indicates the coefficient value of the path set from the j^{th} element (variable) to the i^{th} element (variable). The symbols eQ1, eQ2, . . . indicate errors associated with the individual element (variable). The latent variables, however, have no setting for errors, thereby the latent variables themselves are described there. The test statistical value for each path is recorded together with an ID for each path in a model instance database 52.

In covariance structure analysis, an appropriate estimate for a coefficient value of a path is determined to satisfy standards for likelihood and the like, by comparing the variance and covariance of variables which are calculated from the model of the structural equation with the variance and covariance which are actually measured. In the determination, an estimate value which is statistically more significant is set to be a higher test value for a path.

A modeling operation with the information processor 15a by an operator determines the observed variables and the latent variables included in the structural equation model for the questionnaire results, and an application of the model to the questionnaire results determines analytical results (estimation results). The model components and the analytical results (estimation results) are shown by the data representation of the elements shown in FIG. 3, and stored in the model database 155. The data is converted into the structural equation shown in FIG. 4 for use as needed for comparison of the formulas, presentation of the information to users, or the like.

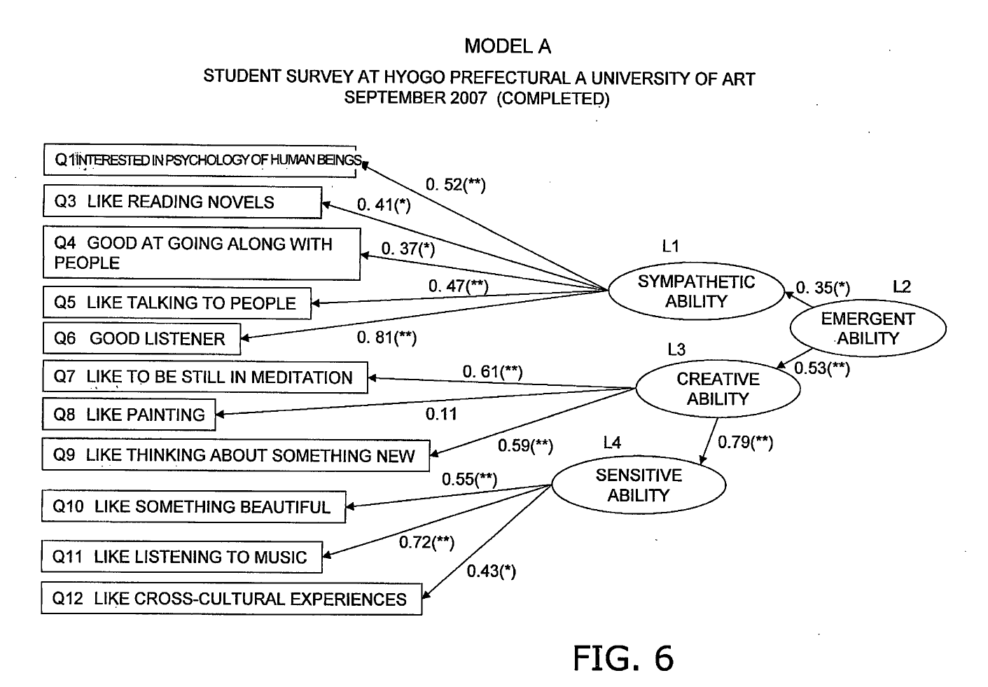

Upon receiving a request for modeling support from the operator who accesses the modeling support system 1 from the information processor 15a via a network while the model B shown in FIGS. 2 to 4 is being generated, the modeling support system 1 operates to extract a model A shown in FIG. 6 which has a similar partial structure, and also extracts the entire structure or a partial structure of the model A similar to the model B, which is presented to the information processors 15a to 15c.

### (Configuration of Modeling Support System)

The modeling support system 1 supports the generation and updating of a model which is used in each of the information processors 15a to 15c, as shown in FIG. 1. The modeling support system 1 collects information of the model from each of the information processors 15a to 15c and stores the information therein. Upon receiving various requests from the information processors 15a, the modeling support system 1 uses the stored information and creates supporting data which is useful to each of the information processors 15a to 15c for generating a model, and outputs the data to each of the information processors 15a to 15c.

The modeling support system 1 includes an interface 2 connected to an interface 156 via a network, a local model manager 3, a model controller 4, a model recorder 5, a distance calculator 6, and a model extractor 7.

### (Configuration of Local Model Manager)

The local model manager 3 requests the model controller 4 for supporting the model generation/improvement performed by each of the information processors 15a to 15c, on the modeling support system 1 side in response to the information processors 15a to 15c. The local model manager 3 includes a local model information obtainer 31 for obtaining model information of each industrial field, and a local model proposer 32 for generating an alternative model better than an object model using the stored reference models. The local model information obtainer 31 obtains the configuration of each component, the rating scales such as test values, a model generating method, and interpretation information of a model generated by each of the information processors 15a to 15c.

### (Configuration of Model Controller)

The model controller 4 acquires the object models generated by the information processors 15a to 15c via the local model manager 3, and also controls the notification of support information to each of the information processors 15a to 15c. The model controller 4 further controls the operations of the local model manager 3, the model recorder 5, and the model extractor 7.

### (Configuration of Model Recorder)

The model recorder 5 stores model components of each of the information processors 15a to 15c, and the configuration of each component, the rating scales such as test values, a model generating method, and interpretation information of the model obtained at the local model information obtainer 31 and the models obtained in other ways. Specifically, the model recorder 5 is provided with a model component database 51 for controlling model components, and a model instance database 52 for controlling model instances such as configuration variables of models. The model component database 51 stores the contents shown in FIG. 3, that is, observed variable names and latent variable names of a model and variable names at the starting points and the end points of paths in association with IDs of the model components. These are the databases for storing parts of each structural equation. That is, a structural equation is constructed with the parts stored in the databases.

The model component database 51 includes: an observed variable database 53 for storing information of observed variables as components (for example, survey questions); a latent variable database 54 for storing latent variables as components (variable key words (for example, ordinary profit, being interested in human beings, ages, Was the lesson interesting?) used in the observed variable, for example, sympathetic ability, creative ability, emergent ability, and sensitive ability, and information type used in each observed variable (e.g., natural numbers, integers, discrete, qualitative variable)); a path database 55 for storing the path which has a proven record among paths between variables as components; and a model-related external information database 56 for storing external information related to the stored models (for example, [information of distance between business types: size of sales: retail dealer<local supermarket<department store<large supermarket], [business geography information: IY Supermarket: Chiba Prefecture, UN Supermarket: Aichi Prefecture]). Because a path can be set between any variables in principle, the path database 55 records paths therein only as examples for reference purpose, which means other paths can be set between starting points and end points of variables that are not stored in the path database 55.

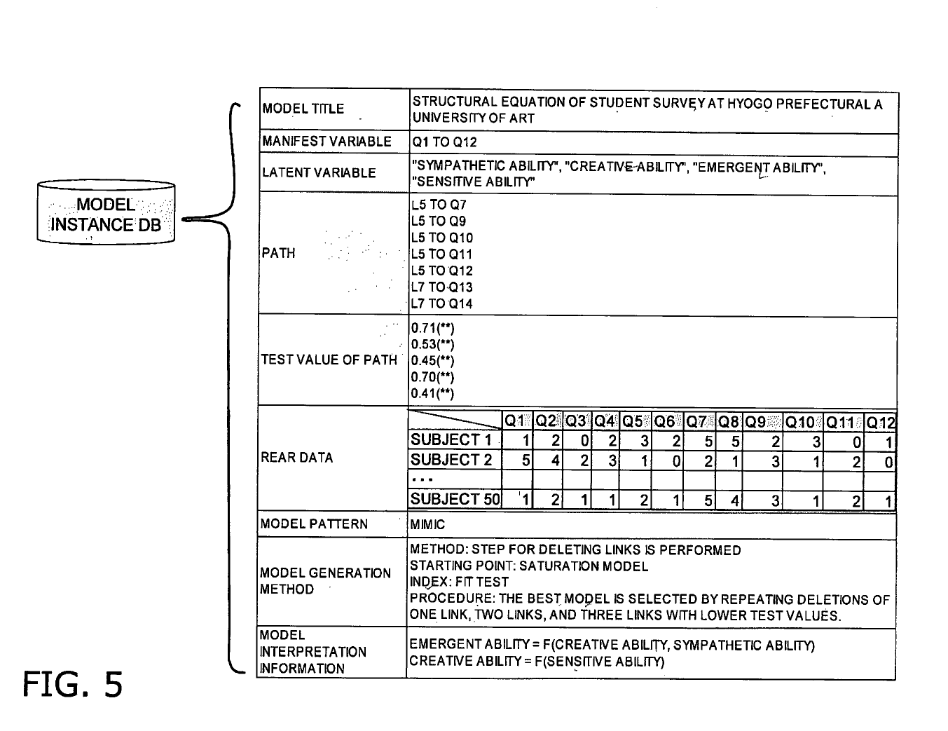

The model instance database 52 stores, as shown in FIG. 5, titles of an already generated models, observed variables, latent variables, paths, test values of paths, real data (for example, questionnaire results), model patterns, modeling methods, and model interpretation information. The model instance database 52 also stores element data of each model in the format shown in FIG. 3 so that a structural equation as that shown in FIG. 4 can be constructed for each model.

### (Configuration of Distance Calculator)

The distance calculator 6 calculates distances between entire models, partial models, and variables individually. Specifically, a distance between models is calculated on the basis of matching between a plurality of models. Then, the models that includes extremely similar elements, or the models that have statistical connections extremely similar to each other have a high matching score. As for distance, there are seven types of distance measures: distance between external attributes; distance between variable attributes; distance between path structures; distance between path coefficients; distance between path coefficient signs; distance between path coefficient significances; and distance between model performances. Among these, the distance measures except the distance between model performances can be applied to a partial structure of a model as well as the entire structure of the model.

The seven types of distances will be explained below.

The distance between external attributes is based on the matching of model titles, target businesses, target samples, times of execution, and the like. The exact match of a distance between external attributes occurs when models have exactly matching target attributes. However, the models having the same samples each other means that they are the same models. Therefore, generally, there can be no case with a distance between external attributes of zero.

The distance between variable attributes is based on the matching of attributes of identifying information such as a group of identifying information of observed variables and identifying information of latent variables which are included in a structural equation. The exact match of a distance between variable attributes occurs when two models have exactly matching groups of observed variable IDs and groups of latent variable IDs. This may actually occur in comparing a plurality of models. The distance between variable attributes includes the two types of distances: one between observed variable and the other between latent variables.

The distance between path structures is based on the matching of paths which are set between observed variables and latent variables which are included in a structural equation. The exact match of a distance between path structures occurs when the elements (latent variables or observed variables) at the origins of the paths exactly match each other. Therefore, the models which do not exactly match each other but are similar to each other are influenced by the similarity distance. Any mismatched path is calculated as a value for a mismatched path, and extends the distance between the models.

The distance between path coefficients is based on the matching of coefficient values which are estimated for the paths set between observed variables and latent variables included in a structural equation. The exact match of a distance between path coefficients occurs when the elements (latent variables or observed variables) at the origins of the paths exactly match each other, as in the case of the distance between path structures. Therefore, the models which do not exactly match each other but are similar to each other are influenced by the similarity distance. Any mismatched path is calculated as a value for a mismatched path, and extends the distance between the models.

The distance between path coefficient sign is based on the matching of coefficient signs which are estimated for the paths set between observed variables and latent variables included in a structural equation. The exact match of a distance between path coefficient signs occurs when the elements (latent variables or observed variables) at the origins of the paths exactly match each other, as in the case of the distance between path structures. Therefore, the models that do not exactly match each other but are similar to each other are influenced by the similarity distance. Any mismatched path is calculated as a value for a mismatched path, and extends the distance between the models.

The distance between path coefficient significances is based on the matching of significant points of coefficient test value which are estimated for the paths set between observed variables and latent variables included in a structural equation. The exact match of a distance between coefficient significances occurs when the elements (latent variables or observed variables) at the origins of the paths exactly match each other, as in the case of the distance between path structures. Therefore, the models that do not exactly match each other but are similar to each other are influenced by the similarity distance. Any mismatched path is counted as a number of mismatched path, and extends the distance between the models.

The distance between model performances is based on the matching of performance measures such as goodness-of-fit test value which is a measure indicating the score of a whole structural equation. The exact match of a distance between model performances occurs when the values of performance measures of models individually match each other.

Now, the calculation of distance between the model B and the model A which is already generated as a result of questionnaire administered to the students at A University of Arts in Hyogo Prefecture shown in FIGS. 6 to 8 will be explained below. Even when given with three or more models, the distance is basically calculated between two of the models at one time and the results are mapped in a coordinate space, so that the distances between the three or more models can be obtained. In calculating distances between three or more models, the indexes to be used may include mean value, deviation, maximum value, minimum value, and median.

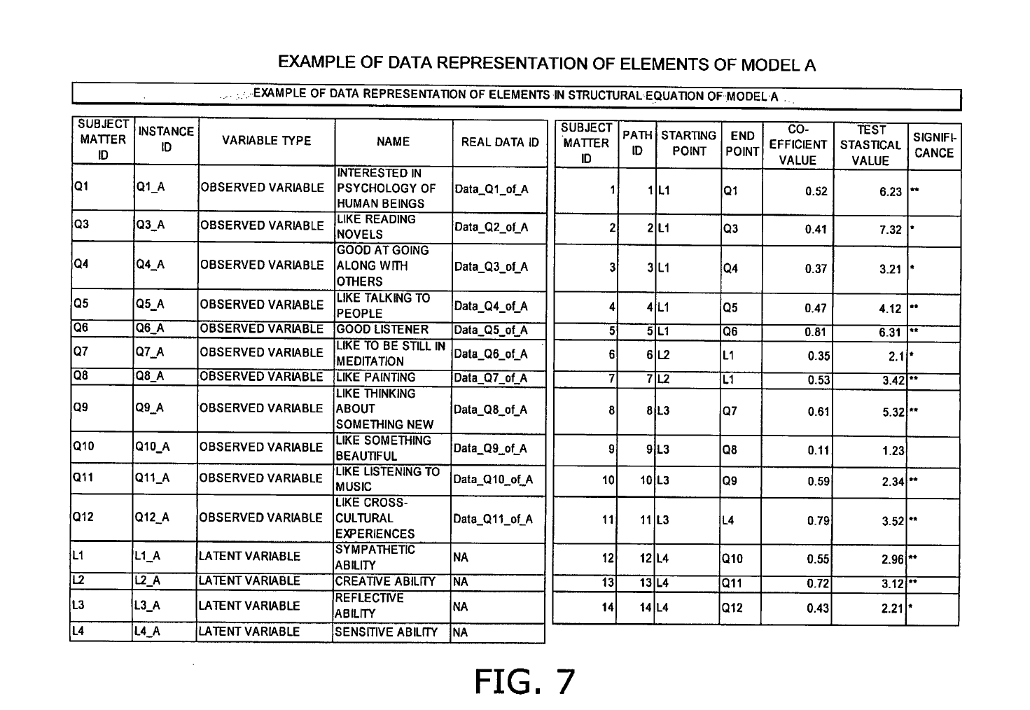

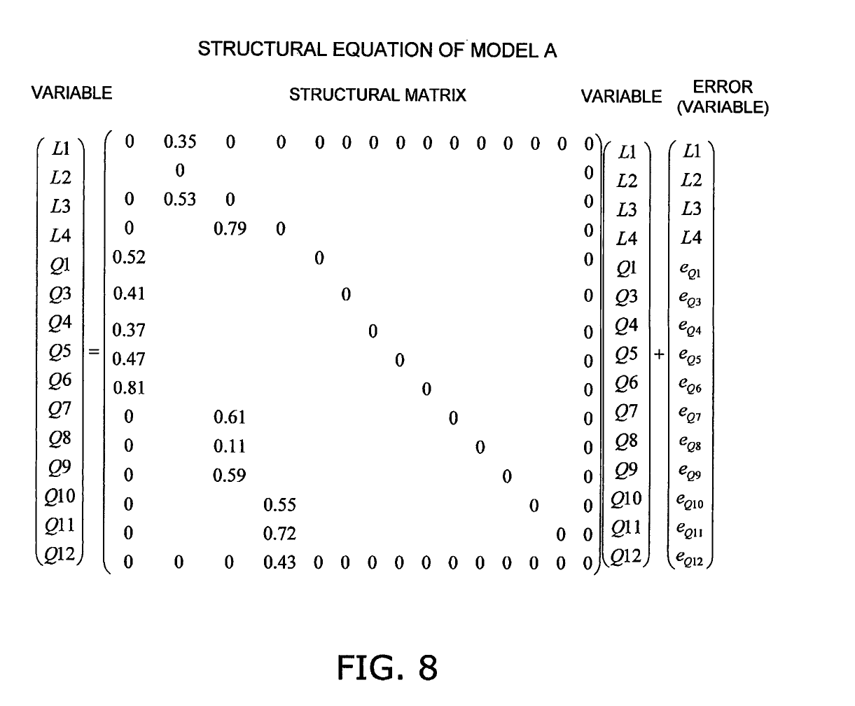

The model A is described by the relations as those shown in FIG. 6. Also, the element data of the model A is shown in FIG. 7 similar to FIG. 3. Moreover, the structural equation is shown in FIG. 8 similar to FIG. 4.

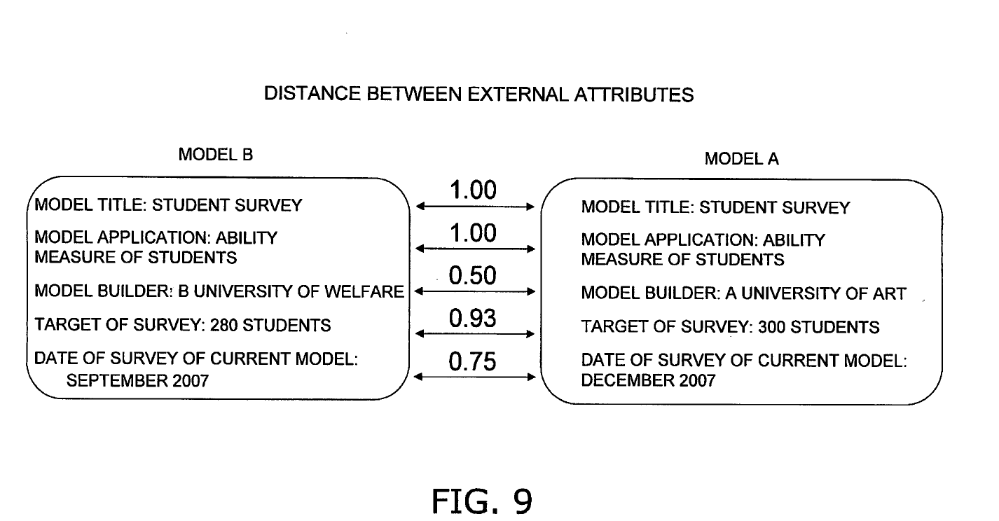

As for the distance between external attributes, as shown in FIG. 9 for example, the matchings of five types of indexes for two models A and B are calculated, and the mean value of the similarities is regarded as the distance. In individual calculation, if needed, the stored data in the model-related external information database 56 may be used.

In FIG. 9, a model title, a model application, a model builder, a target of survey, and a date of survey of a model are selected as the five types of indexes. The model titles and the model applications are exactly matched between the models A and B, thereby the distances of the two indexes are set to 1, individually. The model builders are a university of welfare and a university of arts which can be considered to provide about a half of similarity, thereby the distances of the two indexes are set to 0.5. The target of surveys are 280 students and 300 students respectively, thereby the distance is set to 0.933 according to the formula: (280/300)×1.0. The index for date of survey can be calculated according to 9/12 when a time lag of one year is evaluated to be 0 and a time lag of one month is calculated based on the starting point which is one year before the later month of the two dates; thereby the distance is set to 0.75.

The mean value of the above five types of distances is calculated to obtain a distance between external attributes: (1+1+0.5+0.93+0.75)/5=0.837.

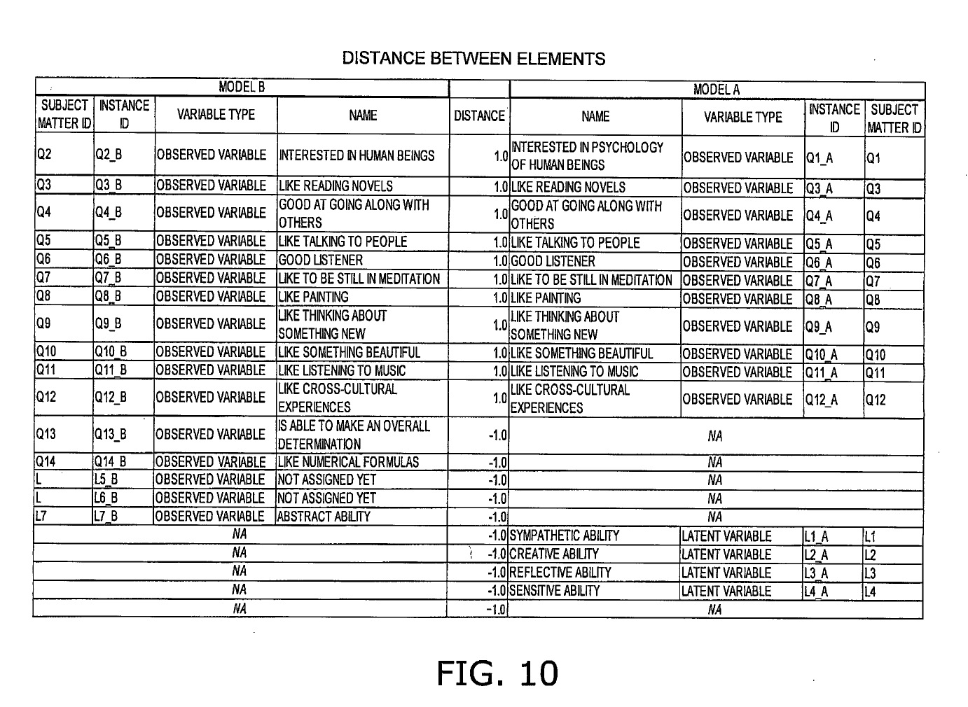

As for the distance between elements, the elements of the models are arranged so that the key words of two models correspond to each other, and the distances between the models are calculated, which are regarded as the distances between elements. One example of distances between elements as the result of rearrangement of the model A and the model B are shown in FIG. 10. In the example, there is no matching in the names of latent variable between the models. To the contrary, the degree of matching between the observed variables is high, and the 11 observed variables are matched with each other out of the 13 observed variables. As a result, the distance of the observed variables is set to 11/13=0.846, and the distance of the latent variables is set to 0.

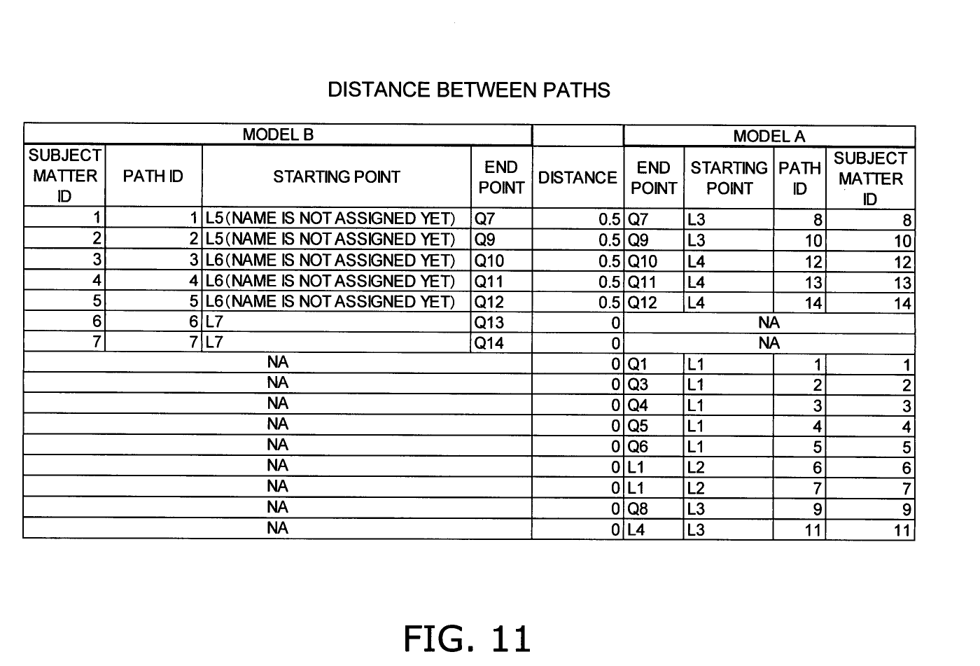

As for the distance between path structures, the two models are arranged so that the paths of models correspond to each other, and the distances between the models are calculated. Typically, the distance is 1 when the end point name and the starting point name are matched with each other. One example of the result of arrangement of the model A and the model B is shown in FIG. 11. In the example, only the distances of paths between a part of the latent variables including the latent variables to which names are not assigned yet. In FIG. 11, the standard distance as a whole is 2.5/16=0.156 because the paths 1 to 5 have the distance of 0.5×5=2.5 and other paths have the distance of 0. The highest value of the distance is 0.5.

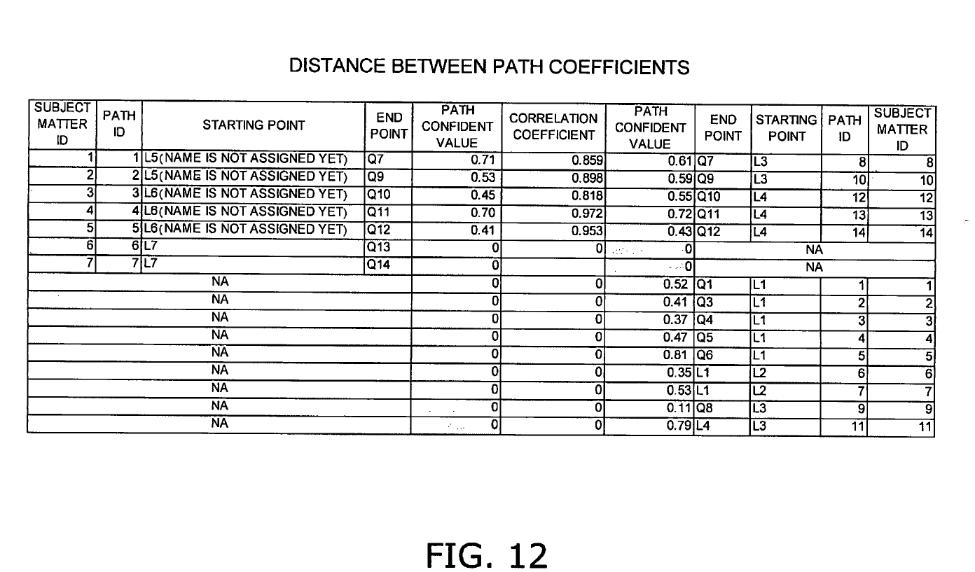

As for the distance between path coefficients, the two models are arranged so that the paths at the same or similar positions correspond to each other, and the correlation coefficients of the models (the matching of directions in which two vectors are directed when the individual combination of the values are considered to be two vectors) are calculated, which are regarded as the distances between path coefficients. One example of the distances between path coefficients as the result of rearrangement of the model A and the model B are shown in FIG. 12. In FIG. 12, the distance for the whole correlation coefficient is 0.3911, but as for the case where a calculation is performed using vectors for only the top five paths having path coefficients in both of the models A and B, the distance expressed by correlation coefficient is a high value of 0.849.

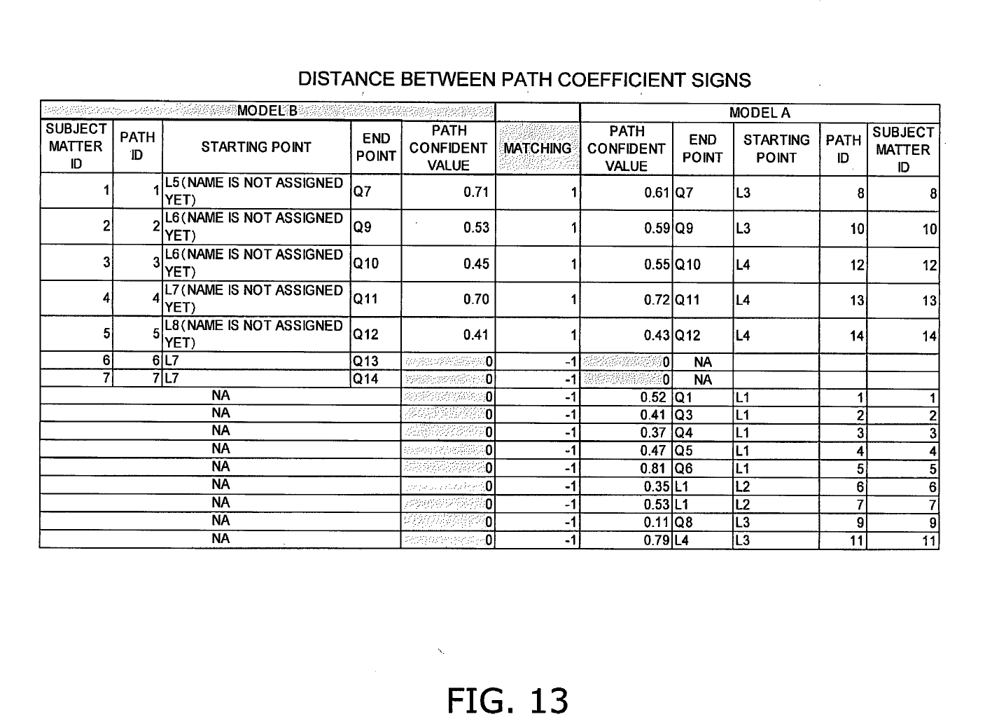

The distance between path sign is an index for measuring the matching of positive/negative signs of path coefficients between two models. As for the distance between path signs, as shown in FIG. 13, the two models are arranged so that the paths correspond to each other, and the distance is determined to be 1 for matched signs, and −1 for mismatched signs. The distance for the path without a corresponding one is also determined to be −1. The overall mean value is set to be the distance between signs. In the example, the distance is 0 because the negative overall mean value is negative. However, as for the top five paths having path coefficients in both of the models A and B, the matching value is 1.

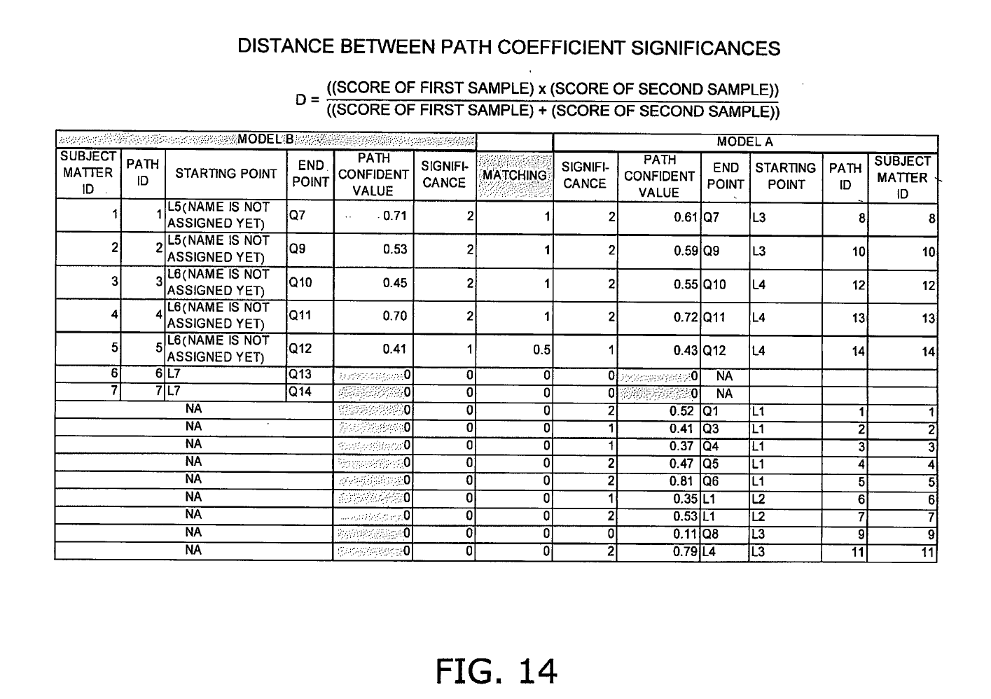

As for the distance between path coefficient significances, a t-test is performed to each path coefficient to calculate test values based on confidence intervals. As shown in FIG. 14, the obtained value for 5% significance level is given by 1 point, and that for the 1% significance level is given by 2 points. Then, the two models are arranged so that the paths correspond to each other, and the indexes d shown in FIG. 14 for the test values of the two models are calculated to obtain the mean value of the indexes, which is set to be the distance between path coefficient significances. In the example shown in FIG. 14, the overall distance is 0.281, and the distance of paths having the top five path coefficients in both of the models is 0.9.

The distance between model performances indicates the deviation from the perfect fit of model, and can be evaluated by an index which is called goodness-of-fit Chi-squared, for example. With respect to the p-values for significance of the goodness-of-fit test, the value for 5% significance level is given by 1 point, and that for the 1% significance level is given by 3 points, as in the case of the distance between path coefficient significances. Then, the two models are arranged so that the paths correspond to each other, and the indexes d for the test values of the two models are calculated to obtain the mean value of the indexes, which is set to be the distance between model performances. The distance is set to have a value within a range of 0 to 1. The measure is applied to the entire structural equation, and an application of the measure to a partial structure reduces the statistical accuracy. Therefore, the index should be used to a model as a whole only. The model A is already completed as a model, while the model B is still being generated, and so an evaluation of the model B cannot be performed yet. Therefore, the distances between model performances of the models A and B cannot be measured yet.

Upon receiving a request for a calculation from the model extractor 7, the distance calculator 6 configured as described above calculates the distance of the entire structure or a partial structure of a plurality of models in response to the request.

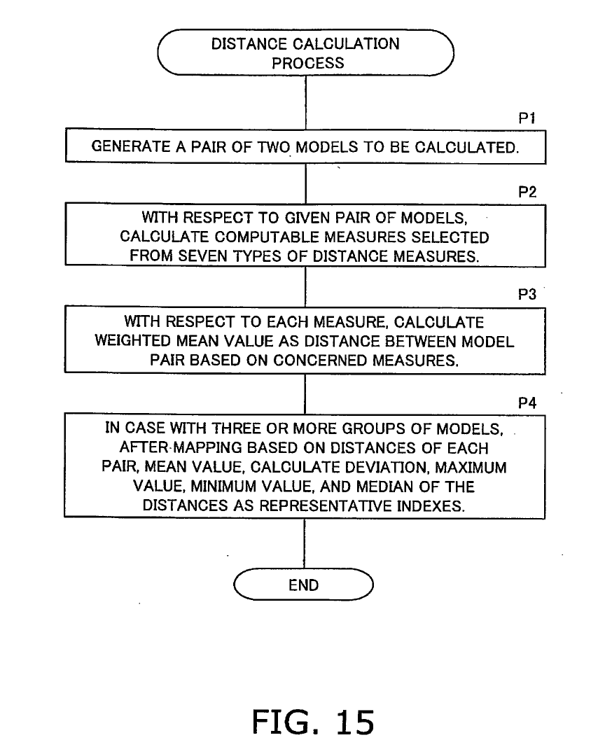

In a distance calculation of models by the distance calculator 6, for example, as shown in FIG. 15, a pair of models to be calculated are generated at Step P1. At Step P2, with respect to the given pair of models, the computable measures are selected from the above described seven types of distance measures, and calculations of the selected measures are performed. At Step P3, the weighted mean value is calculated based on the concerned measures in the distance measures, which is set to be the distance between the pair of models. When partial structures are extracted, the similar processes are done for every partial structure. At Step P4, when three or more groups of models are given, the models are mapped based on the distances of each pair, and the mean value, the deviation, the maximum value, the minimum value, and the median of the distances are calculated, which are set to be the representative indexes of the models.

### (Configuration of Model Extractor)

The model extractor 7 extracts a model or at least a part of a model based on various characteristics of the model. The model extractor 7 includes a model structural characteristics extraction and utilization promoter 71, a model stable/partially independent structure extractor 72, a similar model extractor 73, a latent variable extractor 74, and a focused model performance monitor 75.

The model structural characteristics extraction and utilization promoter 71 recommends a similar model for example which is extracted based on the structural characteristics of the model. The model structural characteristics extraction and utilization promoter 71 is connected with a model structure database 76 and a model performance database 77. The model structure database 76 stores structural characteristics of extracted models (for example, similar structures, partially stable structures, and partially independent structures). The model performance database 77 stores performances of extracted models that change in time series.

The model stable/partially independent structure extractor 72 extracts a partially stable structure or partially independent structure included in a model. The similar model extractor 73 extracts a model similar to a certain model from other models. Specifically, the similar model extractor 73 requests the distance calculator 6 to calculate a distance between an object model (for example, model B) and a reference model which is similar to the object model, so that, according to the calculation result, the entire structure or a partial structure of the similar reference model is extracted as a similar structure. Also, the similar model extractor 73 requests the distance calculator 6 to calculate a distance between a certain reference model and another reference model to extract a common structure or an aggregate structure. Moreover, the similar model extractor 73 compares the generation methods of reference models and that of an object model, and extracts a reference model generated by a method similar to that of the object model as a model having a similar generation method. The similar model extractor 73 includes a similar structure extractor 78, a common structure/aggregate structure extractor 79, and a similar generation method extractor 80.

The similar structure extractor 78 extracts a model having a similar structure to that of the model obtained from the information processors 15a to 15c (one example of an object model) out of the models stored in the model recorder 5 (one example of a reference model), based on the results of the distance calculation from the distance calculator 6 as described above.

The common structure/aggregate structure extractor 79 extracts the models having common parts, or the models which are overlapped with each other for aggregation (complementation) from a group of a plurality of models stored in the model recorder 5. The similar generation method extractor 80 extracts models which are generated by similar methods.

The latent variable extractor 74 extracts latent variables on reference to a reference model similar to an object model. The focused model performance monitor 75 monitors the performance of the model which is closely watched for some reason (for example, for the reason that the model is similar to a certain model). In the case of a virtual model, the focused model performance monitor 75 monitors the performance of the model which is analogically assembled with the performance elements of a plurality of real models.

### (Operation of Modeling Support System)

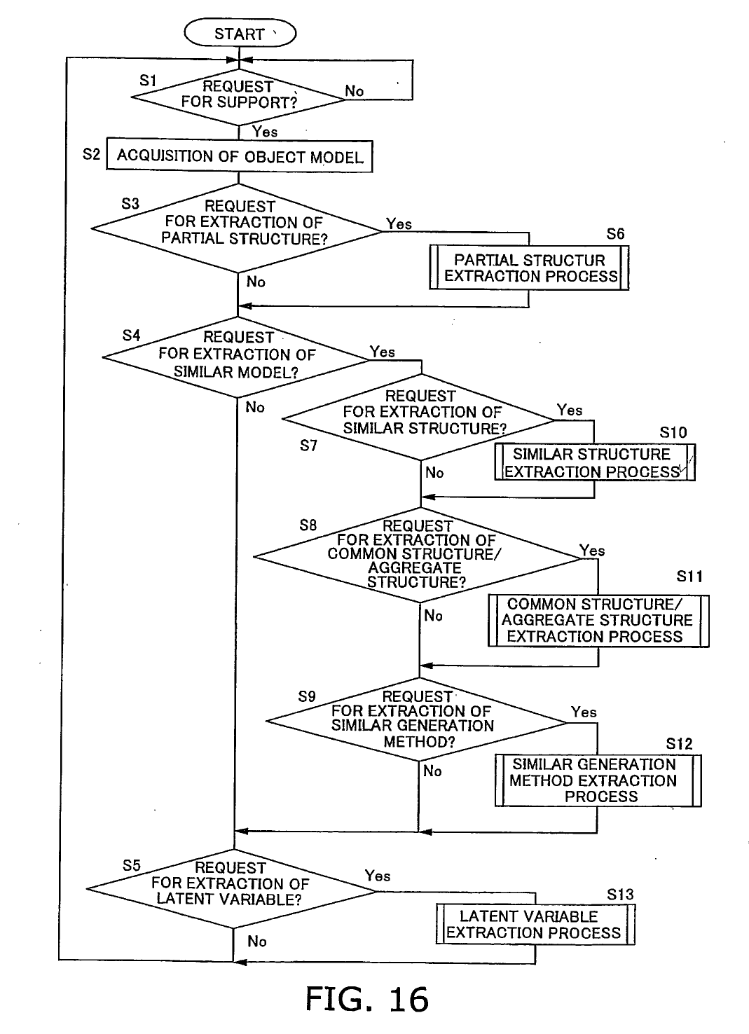

Next, the operation of the modeling support system 1 will be explained below with reference to the flowcharts of the process procedure shown in FIGS. 16 to 21.

At Step S1 of FIG. 16, the modeling support system 1 waits for a support request from the information processors 15a to 15c. An operator of each of the information processors 15a to 15c who desires to request a support while the operator is generating a model notifies the desire to the modeling support system 1 via a network. Upon receiving the request, the processing goes to Step S2. At Step S2, the local model information obtainer 31 obtains the latent variable, the observed variable, and the path (one example of associations) of an object model in the model database 155 of each of the information processors 15a to 15c. At Step S3, it is determined if the information processors 15a to 15c request an extraction of a partial structure or not. At Step S4, it is determined if the information processors 15a to 15c request an extraction of a similar model or not. At Step S5, it is determined if the information processors 15a to 15c request an extraction of a latent variable.

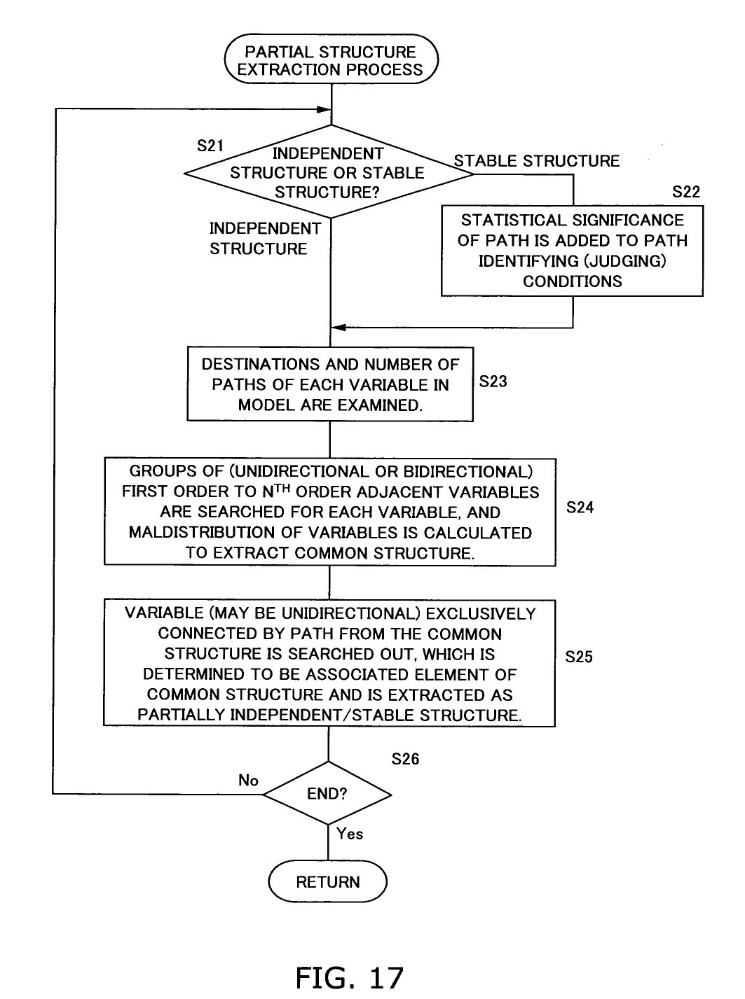

Upon receiving the request for extraction of a partial structure, the process goes from Step S3 to Step S6. At Step S6, the partial structure extraction process shown in FIG. 17 is performed. Upon receiving the request for extraction of a similar model, the process goes from Step S4 to Step S7. At Step S7, it is determined if the information processors 15a to 15c request the extraction of a similar structure or not. At Step S8, it is determined if the information processors 15a to 15c request the extraction of a common structure/aggregate structure or not. At Step S9, it is determined if the information processors 15a to 15c request the extraction of a similar generation method or not.

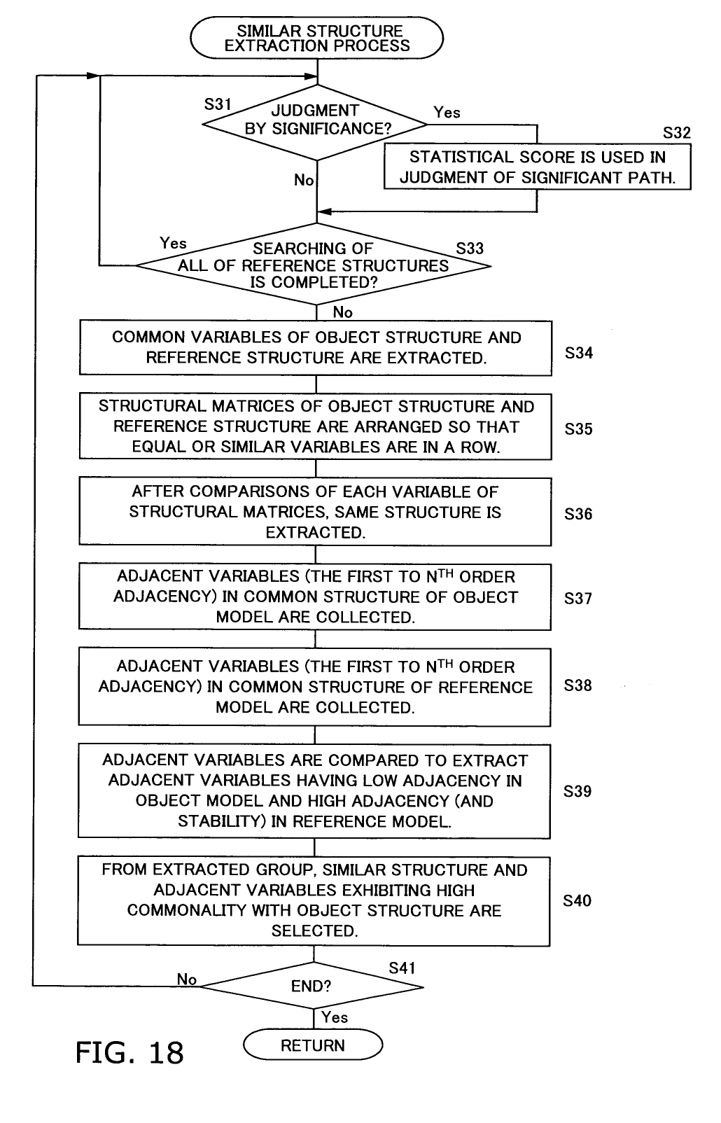

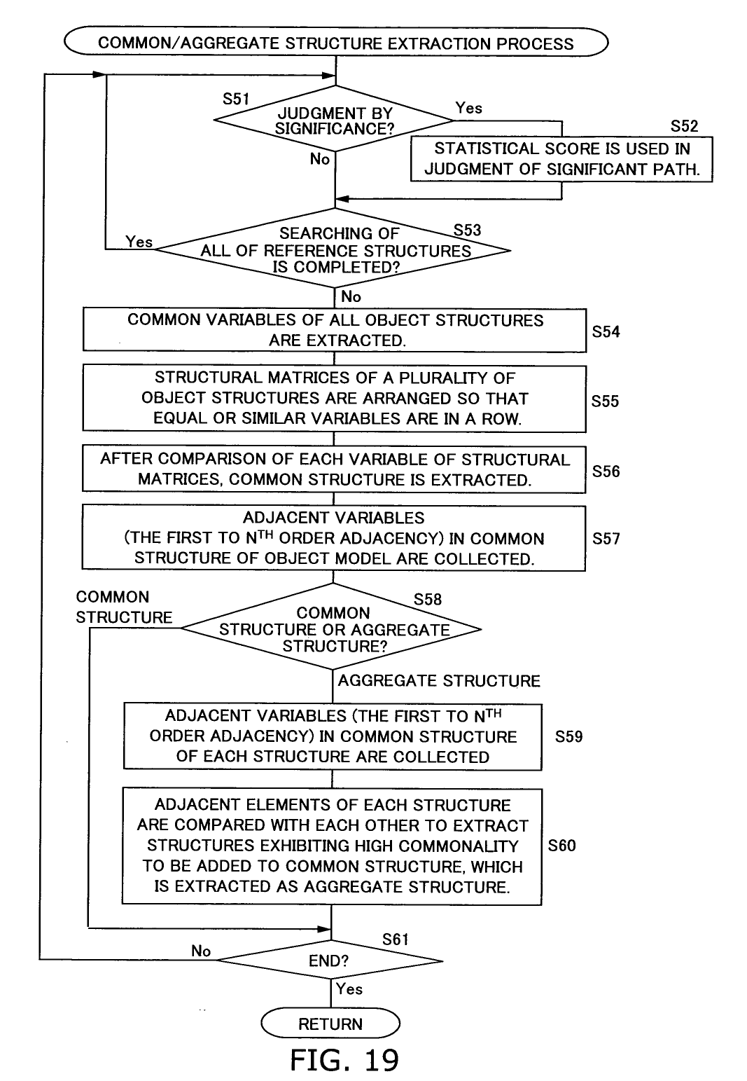

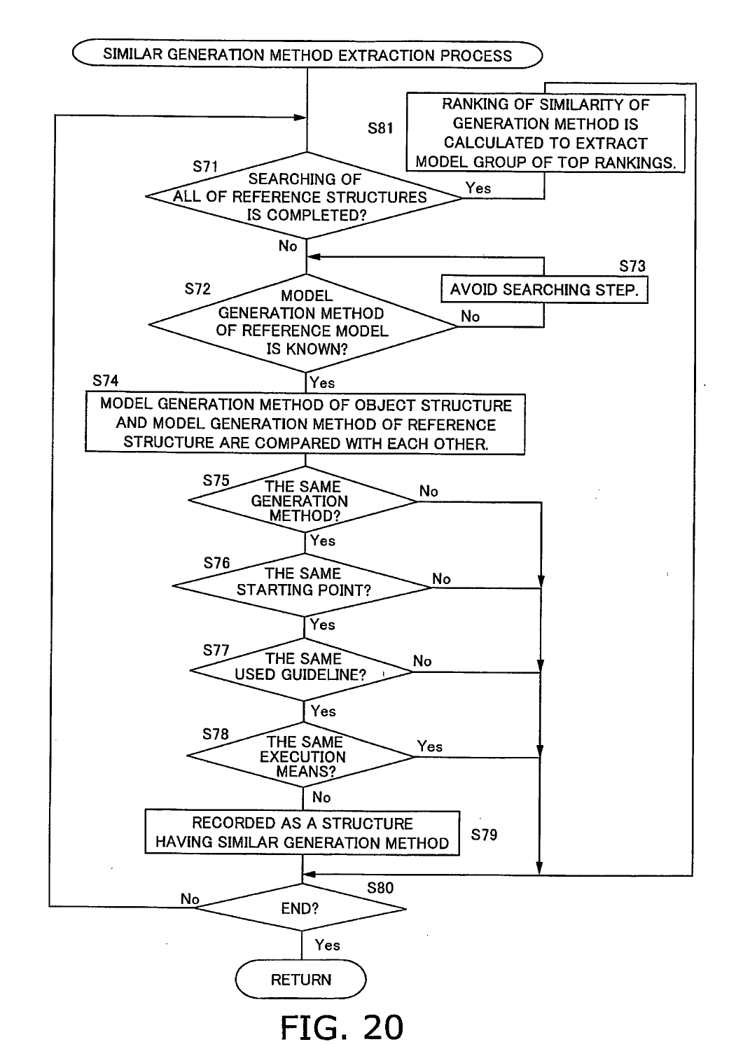

Upon receiving the request for extraction of a similar structure, the process goes from Step S7 to Step S10. At Step S10, the similar structure extraction process shown in FIG. 18 is performed. Upon receiving the request for extraction of a common structure/aggregate structure, the process goes from Step S8 to Step S11. At Step S11, the common structure/aggregate structure extraction process shown in FIG. 19 is performed. Upon receiving the request for extraction of a similar generation method, the process goes from Step S9 to Step S12. At Step S12, the similar generation method extraction process shown in FIG. 20 is performed.

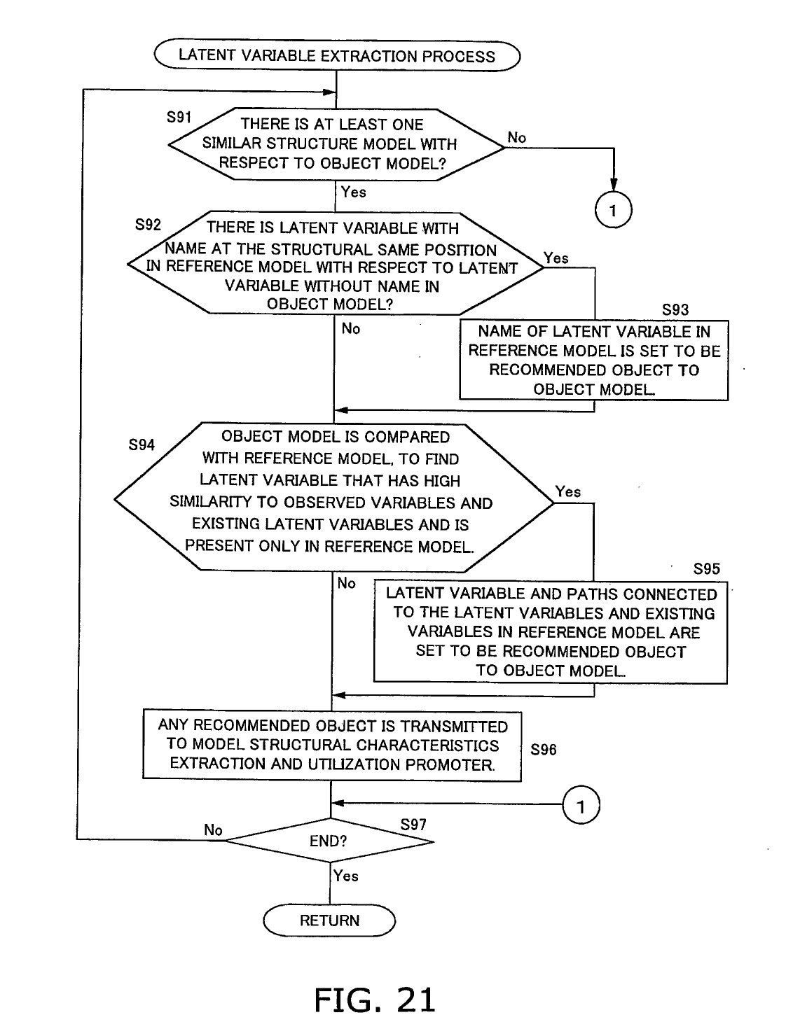

Upon receiving the request for extraction of a latent variable, the process goes from Step S5 to Step S13. At Step S13, the latent variable extraction process shown in FIG. 21 is performed.

The process for partial structure extraction shown in FIG. 17 is performed for a easier comparison between model structures. The operator of the information processors 15a to 15c requests an extraction of a partial structure when a comparison of complicated models is needed. In the partial structure extraction process, a partially independent structure or a partially stable structure is extracted. In FIG. 17, at Step S21, it is determined if the request was made for the extraction of a partial structure or an independent structure. The term “independent structure” as used herein means a partial structure that is constituted with one or a plurality of variables of a model and is considered to be independent because the structure has little association with other partial structures. The term “stable structure” as used herein means a combination of variables in an independent structure that has reliability indicating a statistical significance of a path, that is, a high and stable test value. When it is determined that a stable structure extraction is requested, the process goes from Step S21 to Step S22.

At Step S22, a statistical significance of a path is added to the path identifying conditions. In the case of a request for independent structure extraction, the process goes from Step S21 to Step S23. At Step S23, the destinations and the number of paths of each variable in the model are examined. At Step S24, groups of unidirectional or bidirectional first order to n^{th} order adjacent variables are searched for each variable, and the maldistribution of the variables is calculated to extract a common structure. At Step S25, the variable which is exclusively connected by a path from the common structure, the variable may be unidirectional, is searched out, and the variable is determined to be an associated element of the common structure and is extracted as a partially independent structure or a partially stable structure. At Step S26, it is determined if the request for partial structure extraction is completed or not, and upon an end request, the process goes back to the main routine, otherwise returns to Step S21.

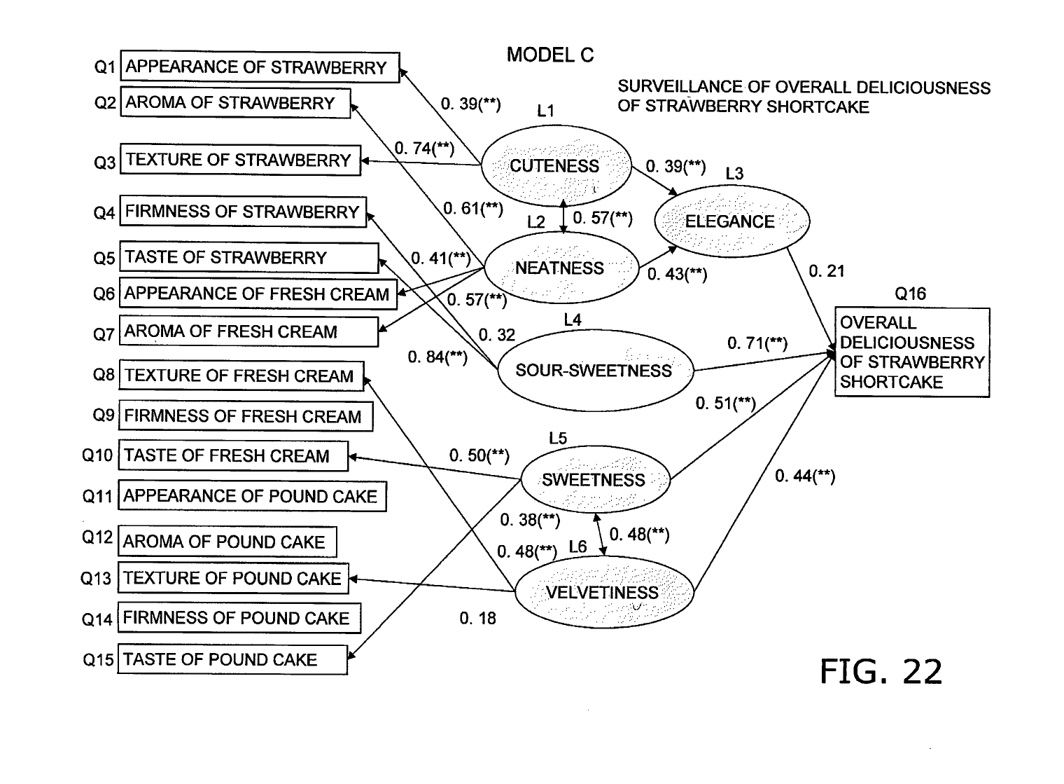

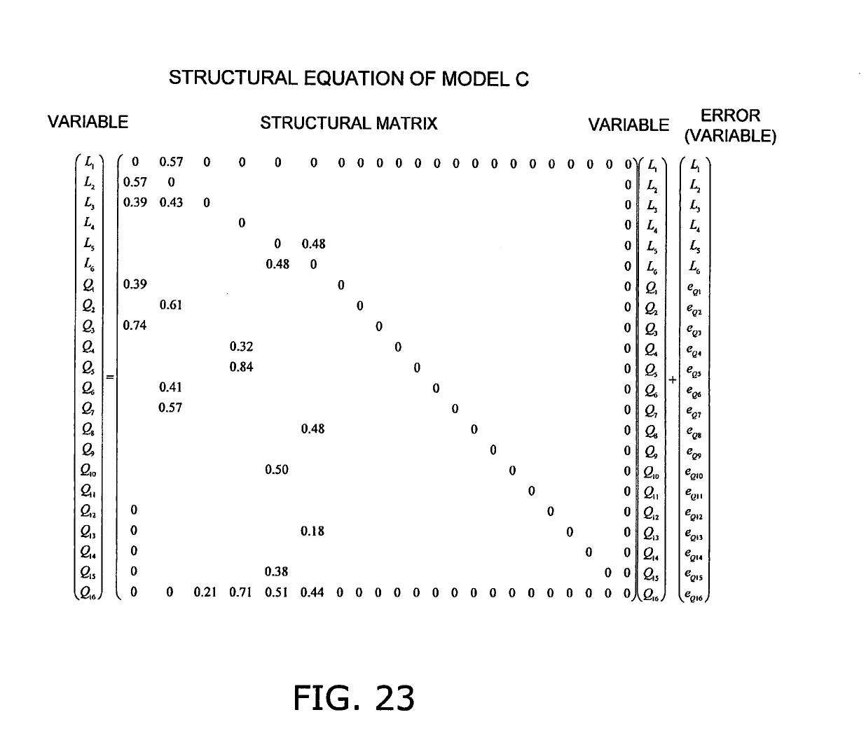

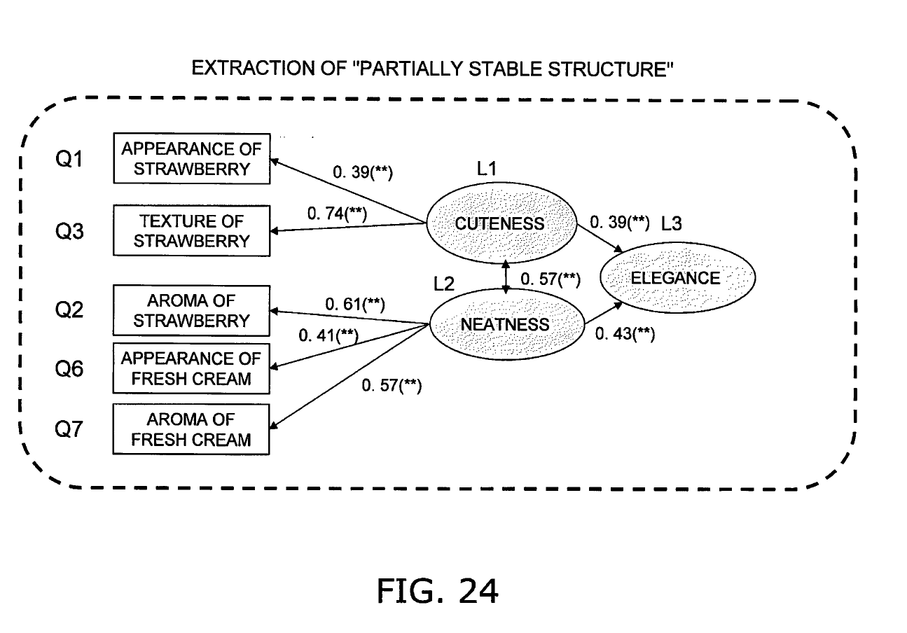

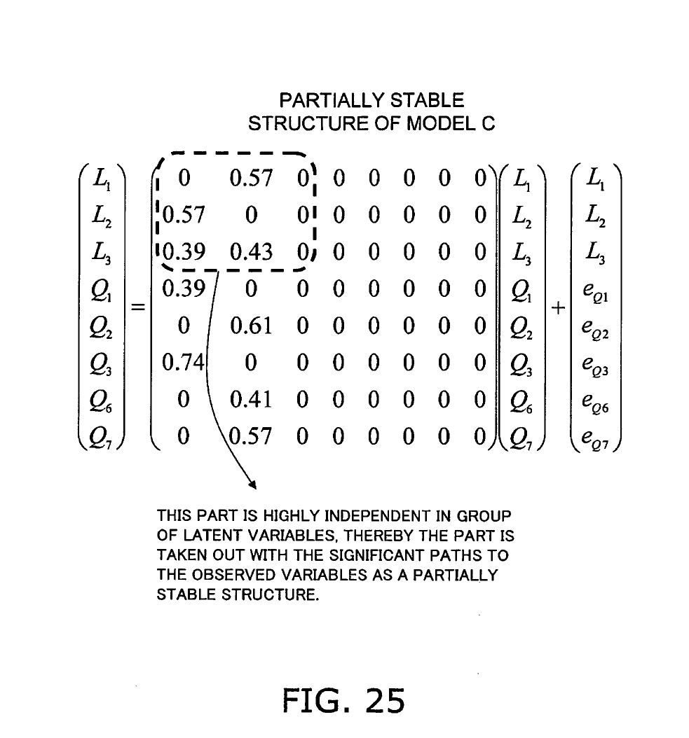

An actual partial structure extraction process will be explained below by the following example of a model C, shown in FIG. 22, of the questionnaire results for surveillance of overall deliciousness of a strawberry shortcake. The entire structure of the model C includes a union of observed variables Q1 to Q16 which are the questions in the questionnaire and latent variables L1 to L7, and the paths connecting between the variables. FIG. 23 shows the structural equation of the model C. At Step S23, the destinations and the number of paths of each variable are examined; at Step S25, a common structure is extracted; and then at Step S26, the variables connected to the common structure by the paths are found out, as the result of that as shown in FIG. 24 and FIG. 25, the partial structure configured with the latent variables L1 to L3 and the observed variables Q1-Q3, Q6, and Q7 is extracted. The part within the dotted lines in FIG. 24 and FIG. 25 is highly independent, thereby the part is taken out and extracted as a partial structure. The partial structure having high path coefficients and test values indicating high significance is determined to be a partially stable structure. The partially stable structure is recorded in the model structure database 76 together with the model name.

Not shown in FIG. 24 and FIG. 25, but the latent variable L4 and the observed variables Q4 and Q5 are extracted as a partially stable structure. Moreover, the latent variable L5 and L6 and the observed variables Q8, Q10, Q13 and Q15 are extracted as a partially independent structure because no statistical significance is found in the paths of the latent variable L5 and the observed variable Q13. These structures are also recorded in the model structure database 76.

In the case of the model A shown in FIG. 6, similarly, it is possible to extract the latent variables L3 and L4 and the observed variables Q7-Q12 as a partially independent structure, and to extract the latent variables L1 and L2 and the observed variables Q1, Q3-Q6 as a partially stable structure. Similarly, in the case of the model B shown in FIG. 2, it is possible to extract the latent variable L5 and the observed variables Q7 and Q9, and the latent variable L6 and the observed variables Q10-Q12 as a partially independent structure respectively.

In the present embodiment, an independent structure having little associations with other partial structures are extracted from the entire complicated model structure, which facilitates the comparison between the partial structures. Also, when a stable structure is extracted, a model with higher reliability can be constructed after the comparison using highly reliable independent structures.

In similar structure extraction process shown in FIG. 18, a similar structure is extracted from a partial structure of an object model which is being generated, based on the resulted partial structure of the reference model and the results of distance calculation requested to the distance calculator 6

Upon a request for an extraction of a similar structure, at Step S31 of FIG. 18, it is determined if statistical significance is one of the judgment conditions for similar structure extraction or not. An operator of each of the information processors 15a to 15c may determine if statistical significance is included in the judgment conditions or not in advance. When statistical significance is one of the judgment conditions, the process goes to Step S32, where a degree of statistical significance is determined to be used in the judgment of the path having a high path coefficient test value, and then the process goes to Step S33. At Step S32, even when statistical significance is included in the judgment conditions, for a path having no determined test value yet, a limitation not to use the statistical value is added to the conditions. When statistical significance is not included in the judgment conditions, the process skips Step S32 and goes to Step S33.

At Step S33, it is determined if the searching of all of the partial structures of the reference model is completed or not. When completed, the process goes back to Step S31. When not yet, the process goes to Step S34. At Step S34, common variables are extracted based on the calculation results of the partial structures of the object model and the partial structures of the reference model. At Step S35, for the comparison between the partial structure of the object model and the partial structure of the reference model, each structural matrices are arranged so that the equal or similar variables (the observed variables and the latent variables) of the two structures are in a row. In the arrangement, the similarity is determined based on the calculated distance of the variable name, and as for the latent variable to which a name is not assigned yet in either structure, the similarity is determined based on the calculation results of distance of path associations, so that the latent variable is positioned in association with a latent variable of the other structure.

At Step S36, after the comparison of each variable of the structural matrices, the same structure is extracted. At Step S37, the adjacent variables (the first to n^{th} order adjacency) in the common structure of the object model are collected. At Step S38, the adjacent variables (the first to n^{th} order adjacency) in the common structure of the reference model are collected. At Step S39, the adjacent variables of the object model and the reference model are compared with each other to extract adjacent variables having low adjacency in the object model and high adjacency (and stability) in the reference model. At Step S40, from the extracted group, a similar structure and adjacent variables exhibiting high commonality with the object structure are selected and extracted as a similar structure. At Step S41, it is determined if the request for partial structure extraction is completed or not, and upon an end request, the process goes back to the main routine, otherwise returns to Step S31.

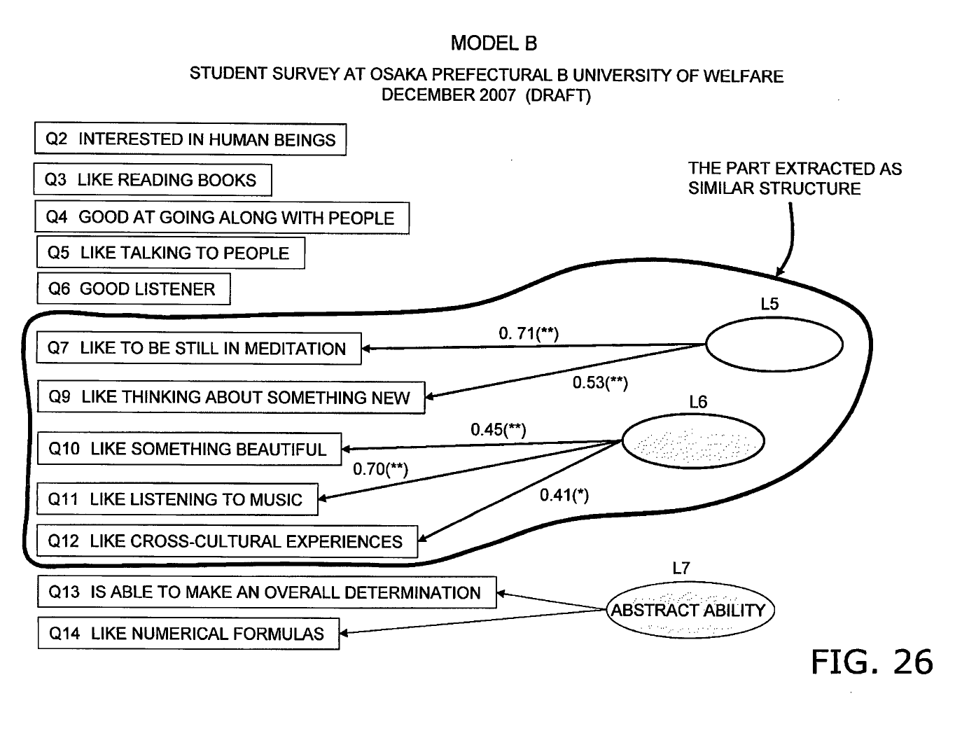

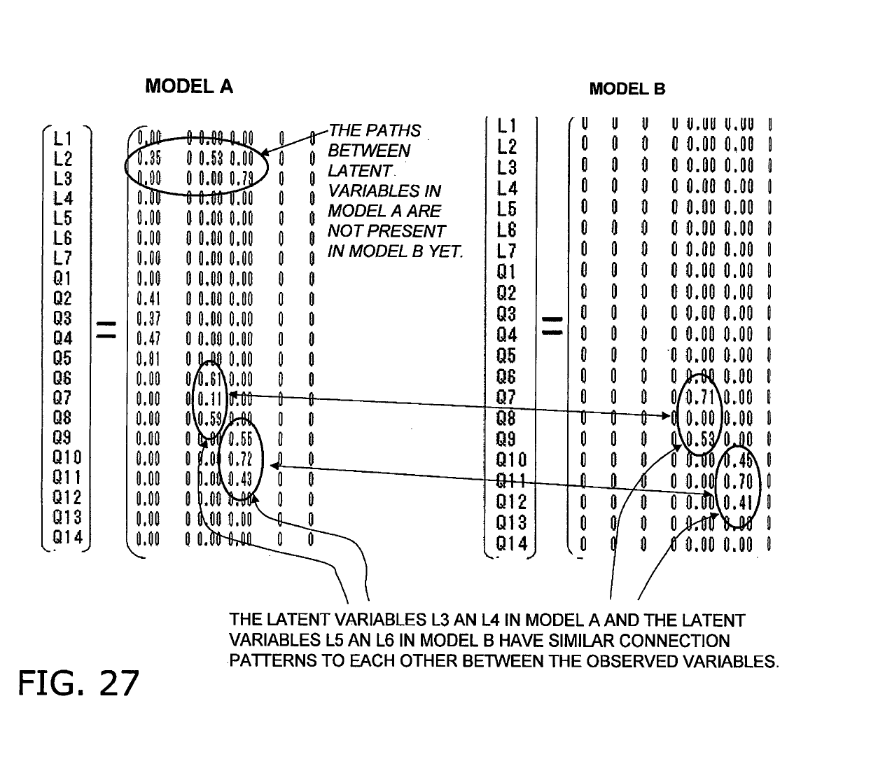

When one of the information processors 15a to 15c which is currently generating the model B shown in FIG. 2 requests an extraction of a similar structure, the distance calculator 6 calculates the distance between the model B and a reference model, and the survey result of the model A at A University of Arts shown in FIGS. 6 to 8 is extracted as a similar model. Then, the partial structure shown in FIG. 26 is extracted as a similar model from the structure of the extracted model A. Specifically, as shown in FIG. 27, with reference to the structural matrices, it is determined that the associated patterns of the latent variables L3 and L4 in the model A having the significant path distances between the observed variables of above the threshold value are similar to those of the latent variables L5 and L6 in the model B, which is extracted as a similar structure.

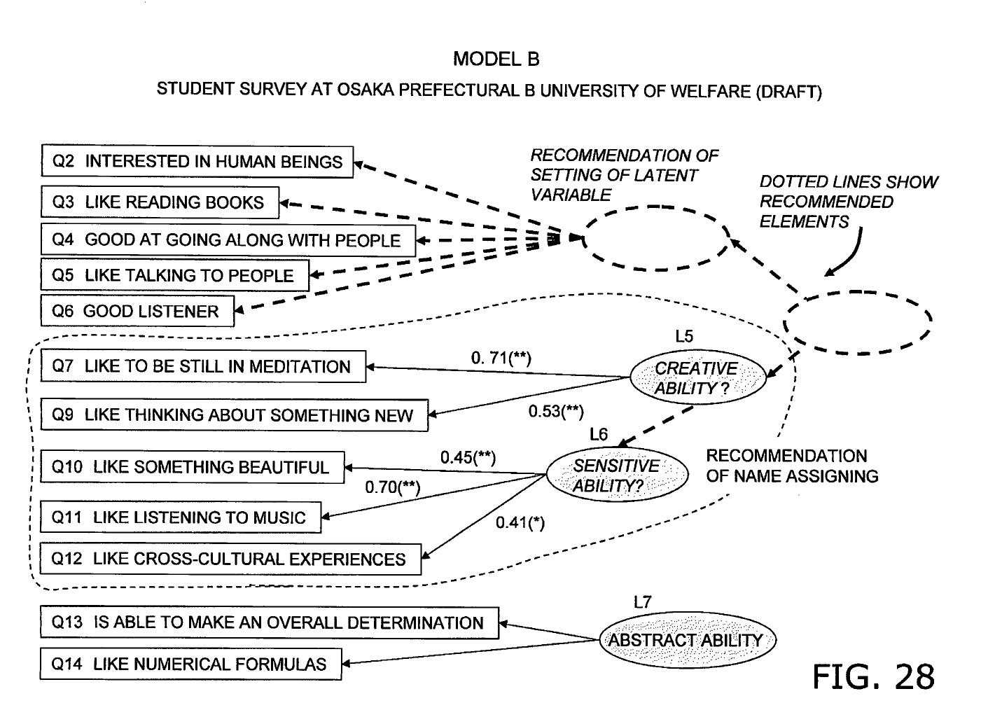

After the similar structure is extracted, as shown in FIG. 28, in the modeling support system 1, in order to the recommendation of a name of the latent variable and the recommendation of setting of the latent variable relative to the observed variable based on the extracted similar structure, the data is sent from the model structural characteristics extraction and utilization promoter 71 to the local model proposer 32 to be outputted to the information processor 15a. The operator of the information processor 15a sees the recommended name and latent variable, and when agreed, the operator applies the recommended name and latent variable to the model B which is being generated.

In the present embodiment, an object model generated by a information processor is compared with a reference model which is obtained from the stored model, so that a similar structure which is similar to a partial structure of the object model is extracted from the reference model, thereby a prediction model can be improved by extracting a model structure from stored models and using the extracted structure.

In the common aggregate structure extraction process shown in FIG. 19, when a plurality of models stored in the modeling support system have a common partial structure, the common structure is extracted. The process is performed upon a request from the local model manager 3, or performed for better recommendation in a batch mode over night or the like without a direct request. The result is sent to the model structural characteristics extraction and utilization promoter 71 to be used for better model proposition. Upon a request for a common structure or aggregate structure extraction, at Step S51 shown in FIG. 19, it is determined if statistical significance is one of the judgment conditions for similar structure extraction or not. An operator of each of the information processors 15a to 15c determines if statistical significance is included in the judgment conditions or not in advance. When statistical significance is also one of the judgment conditions, the process goes to Step S52, where a statistical score is determined to be used in the judgment of the path having a high path coefficient test value, and then the process goes to Step S53. At Step S52, even when statistical significance is included in the judgment conditions, for a path having no determined test value yet, a limitation not to use the statistical value is added to the conditions. When statistical significance is not included in the judgment conditions, the process skips Step S52 and goes to Step S53.

At Step S53, it is determined if the searching of all of the partial structures of the object model are completed or not. When completed, the process goes back to Step S51. When not yet, the process goes to Step S54. At Step S54, common variables in the partial structure of the object model are extracted. At Step S55, for the comparison between the plurality partial structures of the object model, each structural matrices are arranged so that the equal or similar variables (the observed variables and the latent variables) of the two structures are in a row. In the arrangement, the similarity is determined based on the distance of the variable name, and the latent variable to which a name is not assigned yet in any of the structures is positioned in association with a latent variable of the other structure depending on the similarity of path associations.

At Step S56, after the comparison between each variable of the structural matrices, the common structure is extracted. At Step S57, the adjacent variables (the first to n^{th} order adjacency) in the common structure of the object model are collected. At Step S58, it is determined if the request is made for a common structure or an aggregate structure. In the case of the request for an aggregate structure, the process goes to Step 59 where the adjacent variables (the first to n^{th} order adjacency) in the common structure of the plurality structures of object model are collected. At Step S60, the adjacent variables of the plurality of object structures are compared with each other to extract structures exhibiting high commonality to be added to a common structure, which is extracted as an aggregate structure. Then, the process goes to Step S 61. In the case of the request for a common structure, the process goes from Step S58 to Step S61. At Step S61, it is determined if the request for common/aggregate structure extraction is completed or not, and upon an end request, the process goes back to the main routine, otherwise returns to Step S51.

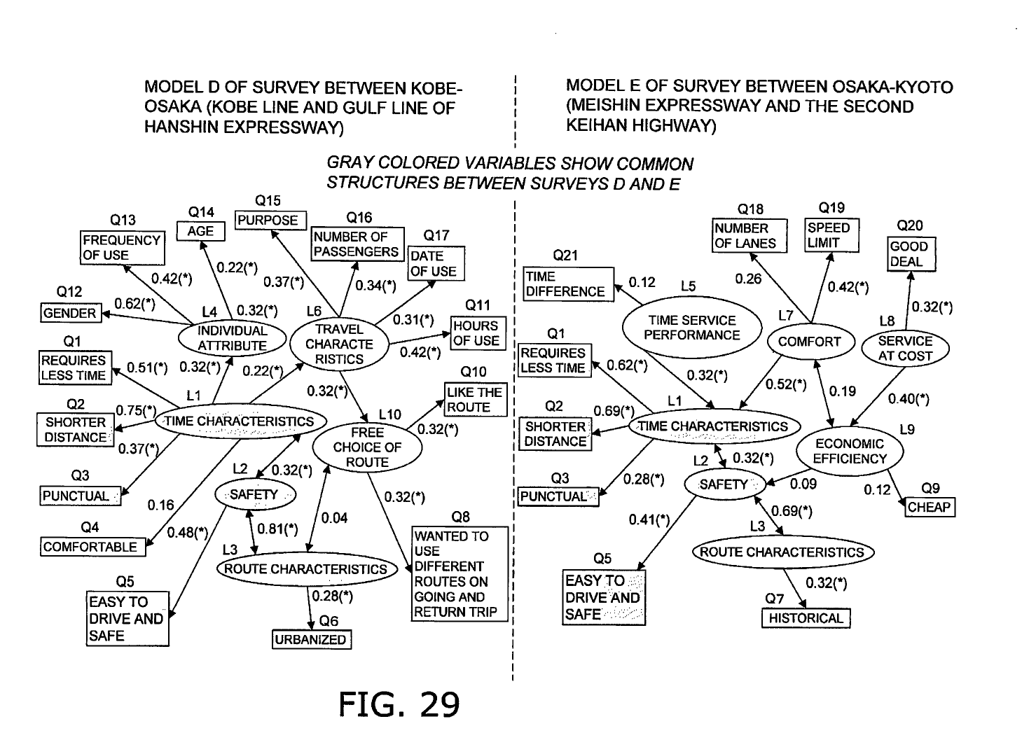

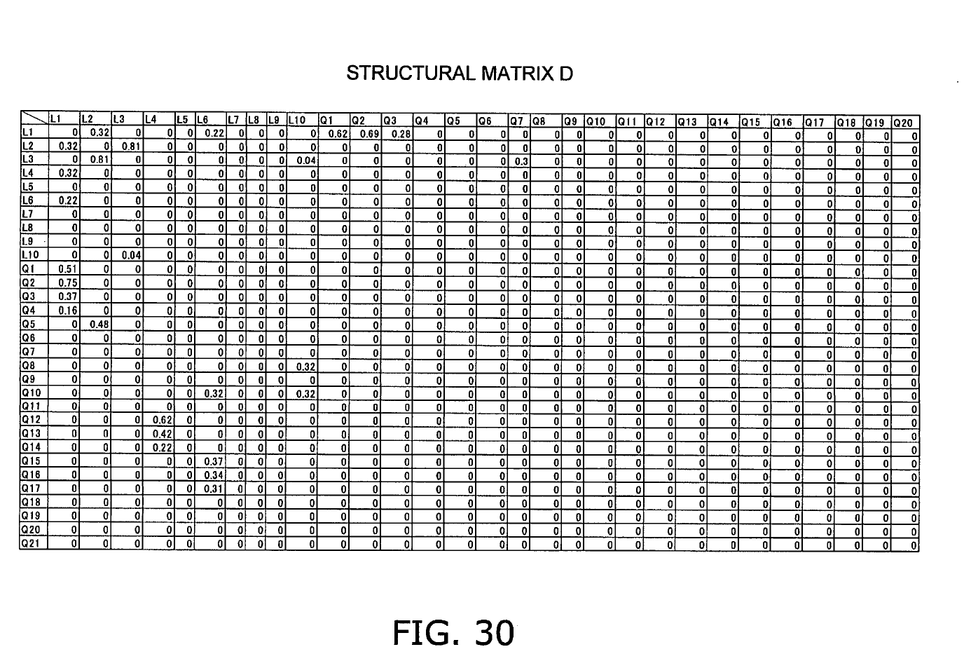

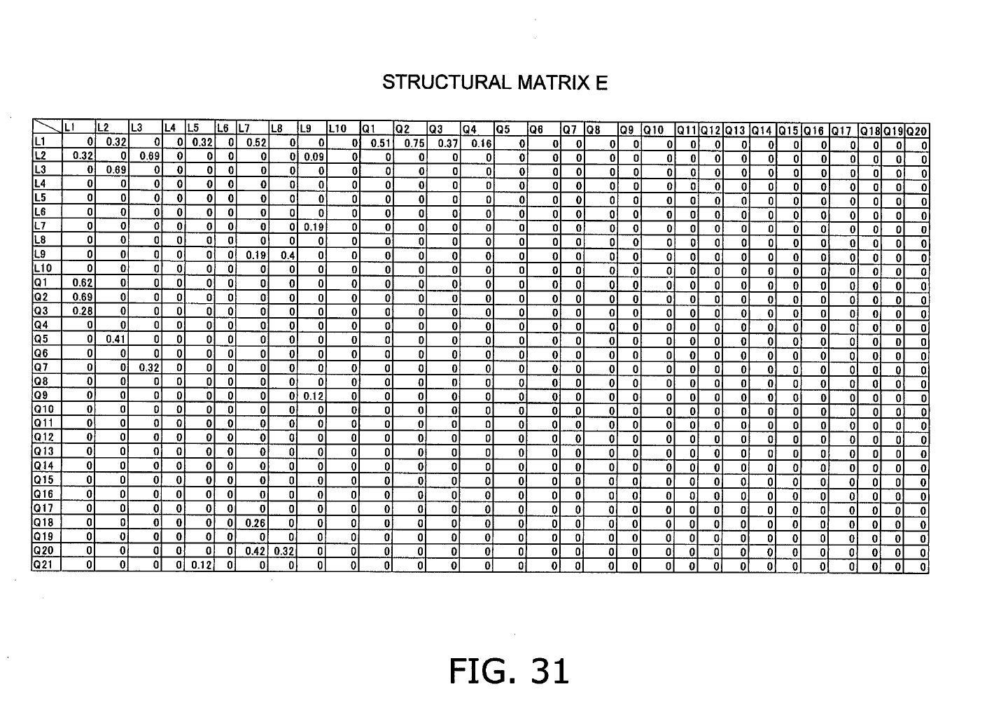

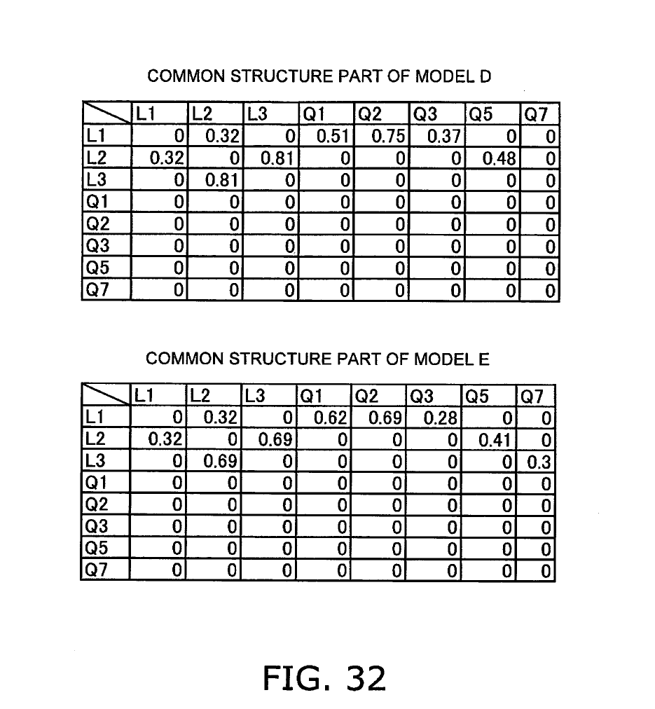

Next, an example of the extraction of a common structure between a model D for the Kobe Line and Gulf line of the Hanshin Expressway between Kobe and Osaka and a model E for the Meishin Expressway and The Second Keihan Highway between Osaka and Kyoto as shown in FIG. 29 will be explained below. In the case, the structural matrix of the survey D shown in FIG. 30 and the structural matrix of the survey E shown in FIG. 31 are arranged so that the same or similar variables are in a line. The result of the arrangement is shown in FIG. 32. In FIG. 32, the variables that are colored gray in FIG. 29 are arranged in a line. Then, the common structure including the latent variables L1-L3 and the observed variables Q1-Q3, Q5, and Q7 is extracted.

In the present embodiment, a common structure and an aggregate structure including the surrounding part can be extracted from a plurality of models, thereby a model having highly reliable components can be generated, and the use of the components allows a construction of a highly reliable model.

In the similar generation method extraction process shown in FIG. 20, at Step S71 of FIG. 20, it is determined if the searching of the structures of all of the reference model in the model recorder 4 are completed or not. When not yet, the process goes to Step S72. At Step S72, it is determined if the generation method of the structure of the reference model is known or not with reference to the model instance database 52. If not, the process goes from Step S72 to Step S73 to avoid the searching step, and returns to Step S72. If so, the process goes from Step S72 to Step S74. At Step S74, the generation method of the structure of the reference model and generation method of the structure of the object model are compared with each other. At Step S75, based on the comparison result, it is determined if the generation method is the same between the reference model and the object model or not. If so, the process goes to Step S76, where it is determined if the starting point of the model is the same between the reference model and the object model or not. The term “starting point of the model” as used herein means the state from which covariance structure analysis is started. In covariance structure analysis, paths can be set with a high degree of freedom, and typically a model is generated through a try and error process. However, if there is a description about how a stable model is generated by deleting paths one by one based on a certain model pattern (e.g., saturated model and MIMIC model) as a starting point, the description can be one reason for the similarity between a certain model and another model.

When the start point models are the same, the process goes to Step S77. At Step S77, it is determined if the used evaluation guideline is similar or the same or not. The guideline is generally chi-squared goodness-of-fit test, but other guidelines such as GFI and AGFI are sometimes used. When the same guideline is used, the process goes to Step S78. At Step S78, it is determined if the execution procedure is the same or not. The execution procedure is the steps for changing the paths, and usually an analyst heuristically (randomly) executes the stops, but when the steps are executed under a certain guideline, the procedure is also one reason for measuring the similarity between a certain model and another model. When the execution means is the same, the process goes to Step S79, where the structure of the reference model is recorded as the structure having a similar generation method. At Step S80, it is determined if an end request is made or not. If not, the process goes back to Step S71, and if so, the process returns to the main routine.

On the other hand, when it is determined that they are not the same at Step S75 to Step S78, the process goes to Step S80. After the searching of the structures of all of the reference models is completed, the process goes from Step S71 to Step S81. At Step S81, the ranking of similarity of each generation method is calculated as the total value as the evaluation result at S75 to S78, and a group of reference models at top rankings is extracted. After the step is completed, the process goes to Step S80.

The above result (e.g., a group of reference models of top three rankings) can be used to support a generation of a model. For example, the local model proposer 32 recommends the group to the information processors 15a to 15c via the model structural characteristics extraction and utilization promoter 71.

In the present embodiment, a known reference model which is generated by a similar method can be extracted, thereby a model can be constructed with reference to the model, which facilitates a generation of a more highly reliable model.

In the latent variable extraction process shown in FIG. 21, at Step S91 of FIG. 21, it is determined if there is a model having at least one similar structure with respect to an object model or not. When there is a similar structure, the process goes to Step S92. At Step S92, it is determined if a latent variable with a name is set at the structural same position in the reference model as that of the latent variable to which a name is not assigned yet in the object model or not. If there is a latent variable with a name, the process goes to Step S93. At Step S93, the name of the latent variable in the reference model is set to be the recommended object to the object model.

If there is not a latent variable with a name, the process goes from Step S92 to Step S94. At Step S94, the object model is compared with the reference model, so that it is determined if there is a latent variable which has high similarity to observed variables and latent variables and is present only in the reference model or not. If there is a latent variable that has high similarity and is present only in the reference model, the process goes to Step S95. At Step S95, the latent variable in the reference model and the paths connected to the existing variables are set to be the recommended objects to the object model. If there is not a latent variable that has high similarity and is present only in the reference model, the process goes to Step S96. At Step S96, when there is any recommended object, the recommended object is transmitted to the model structural characteristics extraction and utilization promoter 71. Then, the model structural characteristics extraction and utilization promoter 71 outputs the recommended object to the local model proposer 32, which in turn recommends the object to the information processors 15a to 15c.

In the present embodiment, as shown in FIG. 28, when the model B as an object model has a partial structure (similar structure) which is similar to the model A as a reference model shown in FIG. 2, the name of the latent variable is recommended to the model B. Specifically, the names of the latent variables L3 and L4 with names in the model A which are disposed at the same positions as those of the latent variable L5 and L6 without names in the model B are recommended as the names of the latent variables in the model B. Therefore, the operator of the information processors 15a to 15c is able to determine the assignment of the name after receiving the recommendation, which simplifies the operation to assign a name of a latent variable, improves the efficiency of the model generation, and reduces the steps for the model generation.

Even if there is not a latent variable with a name at the same position, when there is a latent variable which has high similarity to the observed variables and the latent variables in an object model and is present only in a reference model, the latent variables having high similarity in the reference model are recommended to the positions shown by the dotted lines of FIG. 28 in the object model. Specifically, the latent variables and the paths connected to the existing variables in the reference model are set to be the recommended objects to the object model. As a result, without consideration of latent variables, latent variables and path between observed variables and latent variables can be generated, which facilitates a generation of a model with enhanced analysis efficiency and prediction accuracy.

With respect to the above embodiment, the following appendixes are further disclosed:

### (Appendix)

### (Appendix 1)

A modeling support system accessible to an information processor which generates a model having a structure describing a phenomenon to be analyzed by covariance structure analysis and analyzes the phenomenon, comprising:

a model recorder for storing a model represented with a union of a plurality of observed variables and a plurality of latent variables, and a plurality of paths representing associations between the variables, as a reference model;

a model controller for acquiring an object model which is being generated and is represented by a union of the plurality of observed variables and the plurality of latent variables and the plurality of paths describing the phenomenon to be analyzed, from the information processor; and

a model extractor having a similar structure extractor for comparing the object model with the reference model stored in the model recorder and extracting the entire structure or a partial structure of the reference model which is similar to the entire structure or a partial structure of the object model as a similar structure, when receiving a request from the information processor for supporting the generation of the object model, and

the model controller notifies the similar structure extracted by the similar structure extractor to the information processor.

### (Appendix 2)

The modeling support system according to Appendix 1, wherein

when the partial structure of the object model for which the similar structure is extracted includes comparing the object model with the reference model from the reference model,

the model extractor further comprises a latent variable extractor for, when the reference model from which the similar structure is extracted includes a latent variable as an element, confirming that the object model does not include a corresponding latent variable, and extracting the latent variable, and

the model controller notifies the extracted latent variable to the information processor.

### (Appendix 3)

The modeling support system according to Appendix 1 or 2, wherein

the model extractor further comprises a stable structure extractor for extracting a structure including a union of the observed variables and the latent variables having significant paths therebetween from the independent structure as a stable structure.

### (Appendix 4)

The modeling support system according to Appendix 3, wherein:

the model extractor further comprises a stable structure extractor for extracting a stable structure including the latent variables in which the observed variables and the latent variables have significant associations with each other, from the independent structure.

### (Appendix 5)

The modeling support system according to any one of Appendixes 1 to 4, wherein

the model extractor further comprises a common structure extractor for extracting partial structures from a plurality of the reference models, and extracting a common structure which is common to the extracted partial structures.

### (Appendix 6)

The modeling support system according to Appendix 5, wherein

the model extractor further comprises an aggregate structure extractor for extracting partial structures from a plurality of the reference models, and extracting an aggregate structure which is formed by aggregating the extracted partial structures.

### (Appendix 7)

The modeling support system according to any one of Appendixes 1 to 6, wherein

the model extractor further comprises a similar generation method extractor for extracting a reference model which is generated by a model generating method similar to that of the object model.

### (Appendix 8)

The modeling support system according to any one of Appendixes 1 to 7, wherein

the model extractor further comprises a model performance monitor for monitoring the performance of a predetermined reference model to real data in time series.

### (Appendix 9)

The modeling support system according to any one of Appendixes 1 to 8, wherein

the model extractor further comprises a model structure database for storing structural characteristics of the model having the similar structure.

### (Appendix 10)

A modeling support method executed by a computer accessible to an information processor which generates a model having a structure describing a phenomenon to be analyzed by covariance structure analysis and analyzes the phenomenon, comprising:

a model recording step by a model controller of the computer for acquiring a model represented with a union of a plurality of observed variables and a plurality of latent variables, and a plurality of paths representing associations between the variables, as a reference model;

a model controlling step by a model controller of the computer for acquiring an object model which is being generated and is represented by a union of the plurality of observed variables and the plurality of latent variables and the plurality of paths of the object model to be analyzed, from the information processor;

a similar structure extracting step for comparing the object model with the reference model stored in the model recorder, and extracting the entire structure or a partial structure of the reference model which is similar to the entire structure or a partial structure of the elements included in the object model as a similar structure, upon a request from the information processor for supporting the generation of the object model, and

a notifying step by the model controller for notifying the similar structure extracted by the similar structure extractor to the information processor.

### (Appendix 11)

A modeling support program executed by a computer accessible to an information processor which generates a model having a structure describing a phenomenon to be analyzed by covariance structure analysis and analyzes the phenomenon, wherein it implements:

a model recording function for storing a model represented with a union of a plurality of observed variables with data and a plurality of latent variables without data, and a plurality of paths representing associations between the variables, as a reference model;

a model controlling function by a model controller of the computer for acquiring an object model which is being generated and is represented with a union of the plurality of observed variables and the plurality of latent variables, and the plurality of paths of the object model to be analyzed;

a similar structure extracting function for comparing the object model with the reference model stored in the model recorder, and extracting the entire structure or a partial structure of the reference model which is similar to the entire structure or a partial structure of the elements included in the object model as a similar structure, upon a request from the information processor for supporting the generation of the object model, and

a notifying function by the model controller for notifying the similar structure extracted by the similar structure extractor to the information processor.

The modeling support system disclosed above is useful for modeling with higher prediction accuracy executed by an information processor which generates a model by analyzing data describing a certain phenomenon, and predicting a future phenomenon using the model

### [Description of Symbols]

1 modeling support system
3 local model manager
4 model controller
5 model recorder
7 model extractor
15a to 15c information processor
72 partially stable/partially independent structure extractor
73 similar model extractor
74 latent variable extractor
78 similar structure extractor
79 common structure/aggregate structure extractor
80 similar generation method extractor

What is claimed is:

1. Modeling support system accessible to an information processor which generates a model having a structure describing a phenomenon to be analyzed by covariance structure analysis and analyzes the phenomenon, comprising:
a model recorder for storing a model represented with a union of a plurality of observed variables with data and a plurality of latent variables without data, and a plurality of paths representing associations between the variables, as a reference model;
a model controller for acquiring an object model which is being generated and is represented by a union of the plurality of observed variables and the plurality of latent variables and the plurality of paths describing the phenomenon to be analyzed, from the information processor; and
a model extractor having a similar structure extractor for comparing the object model with the reference model stored in the model recorder and extracting the entire structure or a partial structure of the reference model which is similar to the entire structure or a partial structure of the object model as a similar structure, when receiving a request from the information processor for supporting the generation of the object model, and
the model controller notifies the similar structure extracted by the similar structure extractor to the information processor.

2. The modeling support system according to claim 1, wherein
when the partial structure of the object model for which the similar structure is extracted includes comparing the object model with the reference model from the reference model,
the model extractor further comprises a latent variable extractor for, when the reference model from which the similar structure is extracted includes a latent variable as an element, confirming that the object model does not include a corresponding latent variable, and extracting the latent variable, and
the model controller notifies the extracted latent variable to the information processor.

3. The modeling support system according to claim 1, wherein
the model extractor further comprises an independent structure extractor for extracting a structure which includes a union of one or a plurality of observed variables and latent variables and has paths and has little paths associated with other structure, as an independent structure from a plurality of structures of the reference models.

4. The modeling support system according to claim 3, wherein
the model extractor further comprises a stable structure extractor for extracting a structure including a union of the observed variables and the latent variables having significant paths therebetween, as a stable structure from the independent structure.

5. The modeling support system according to claim 1, wherein
the model extractor further comprises a common structure extractor for extracting partial structures from a plurality of the reference models, and extracting a common structure which is common to the extracted partial structures.

6. The modeling support system according to claim 1, wherein
the model extractor further comprises an aggregate structure extractor for extracting partial structures from a plurality of the reference models, and extracting an aggregate structure which is formed by aggregating the extracted partial structures.

7. The modeling support system according to claim 1, wherein
the model extractor further comprises a similar generation method extractor for extracting a reference model which is generated by a model generating method similar to that of the object model.

8. The modeling support system according to claim 1, wherein
the model extractor further comprises a model performance monitor for monitoring the performance of a predetermined reference model to real data in time series.

9. A modeling support method executed by a computer accessible to an information processor which generates a model having a structure describing a phenomenon to be analyzed by covariance structure analysis and analyzes the phenomenon, comprising:
a model recording step for storing a model represented with a union of a plurality of observed variables with data and a plurality of latent variables without data, and a plurality of paths representing the associations between the variables, as a reference model;
a model controlling step by a model controller of the computer for acquiring an object model which is being generated and is represented with a union of the plurality of observed variables and the plurality of latent variables and the plurality of paths of the object model to be analyzed, from the information processor;
a similar structure extracting step for comparing the object model with the reference model stored in the model recorder, and extracting the entire structure or a partial structure of the reference model which is similar to the entire structure or a partial structure of the elements included in the object model as a similar structure, upon a request from the information processor for supporting the generation of the object model, and
a notifying step by the model controller for notifying the similar structure extracted by the similar structure extractor to the information processor.

10. A computer-readable storage medium storing a modeling support program executed by a computer accessible to an information processor which generates a model having a structure describing a phenomenon to be analyzed by covariance structure analysis and analyzes the phenomenon, implementing:
a model recording function for storing a model represented with a union of a plurality of observed variables with data and a plurality of latent variables without data, and a plurality of paths representing associations between the variables, as a reference model;
a model controlling function by a model controller of the computer for acquiring an object model which is being generated and is represented with a union of the plurality of observed variables and the plurality of latent variables and the plurality of the paths of the object model to be analyzed;
a similar structure extracting function for comparing the object model with the reference model stored in the model recorder, and extracting the entire structure or a partial structure of the reference model which is similar to the entire structure or a partial structure of the elements included in the object model as a similar structure, upon a request from the information processor for supporting the generation of the object model, and
a notifying function by the model controller for notifying the similar structure extracted by the similar structure extractor to the information processor.
